(19) United States
(12) Patent Application Publication
(10) Pub. No.: US 2026/0246576 A1
(43) Pub. Date: Aug. 20, 2026

(54) FLEXIBLE CARRIER AGGREGATION IN WIDE BANDWIDTHS

(71) Applicant: Lenovo (United States) Inc., Morrisville, NC (US)

(72) Inventor: Hyejung Jung, Northbrook, IL (US)

(73) Assignee: Lenovo (United States) Inc., Morrisville, NC (US)

(21) Appl. No.: 19/054,709

(22) Filed: Feb. 14, 2025

(51) Int. Cl. H04L 5/00; H04L 1/1812; H04W 24/08; H04W 36/08; H04W 68/00; H04W 72/1268; H04W 72/232; H04W 74/0833

(52) U.S. Cl. CPC H04L 5/001; H04L 1/1812; H04L 5/0048; H04W 24/08; H04W 36/08; H04W 68/00; H04W 72/1268; H04W 72/232; H04W 74/0833

(57) ABSTRACT

Various aspects of the present disclosure relate to flexible carrier aggregation in wide bandwidths. A user equipment (UE) receives a configuration for a serving cell, where the serving cell is associated with a set of component carriers (CCs). The set of CCs share a same frame timing, a same system frame number (SFN), and a same hybrid automatic repeat request (HARQ) entity. In some examples, the configuration indicates one physical cell identifier (PCID) for the serving cell, where the set of CCs are associated with the PCID. In other examples, the configuration indicates two or more PCIDs for the serving cell, where each PCID corresponds to a respective CC. In some examples, the UE receives a message, such as a medium access control control element (MAC-CE), indicating a CC to be used for random access and/or a CC to be used for monitoring for paging messages.

### TECHNICAL FIELD

The present disclosure relates to wireless communications, and more specifically to flexible carrier aggregation techniques for efficient utilization of multiple component carriers in next-generation radio access networks.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a configuration for a serving cell, where the serving cell is associated with a set of component carriers (CCs), and where the configuration indicates at least one physical cell identity (PCID) associated with the serving cell, and receive wireless communication from the serving cell via a set of downlink channels associated with the set of CCs and based on the at least one PCID.

A processor (e.g., a standalone processor chipset, or a component of a UE) for wireless communication is described. The processor may be configured to, capable of, or operable to perform one or more operations as described herein. For example, the processor may be configured to, capable of, or operable to receive a configuration for a serving cell, where the serving cell is associated with a set of CCs, and where the configuration indicates at least one PCID associated with the serving cell, and receive wireless communication from the serving cell via a set of downlink channels associated with the set of CCs and based on the at least one PCID.

A method performed or performable by a UE for wireless communication is described. The method may include receiving a configuration for a serving cell, where the serving cell is associated with a set of CCs, and where the configuration indicates at least one PCID associated with the serving cell, and receiving wireless communication from the serving cell via a set of downlink channels associated with the set of CCs and based on the at least one PCID.

In some implementations of the UE, the processor, and the method described herein, the UE, the processor, and the method may further be configured to, capable of, or operable to share a same frame timing, a same system frame number (SFN), and a same hybrid automatic repeat request (HARQ) entity among the set of CCs. In some implementations of the UE, the processor, and the method described herein, the configuration indicates that the at least one PCID is associated with the set of CCs, and the UE, the processor, and the method may further be configured to, capable of, or operable to receive at least one synchronization signal block (SSB) of the serving cell via at least one CC of the set of CCs, where the at least one SSB is associated with the at least one PCID. In some implementations of the UE, the processor, and the method described herein, the at least one PCID includes a set of PCIDs, and where each PCID of the set of PCIDs is associated with a different CC of the set of CCs. In some implementations of the UE, the processor, and the method described herein, the UE, the processor, and the method may further be configured to, capable of, or operable to receive a set of SSBs, where each SSB of the set of the SSBs is associated with a different PCID of the set of PCIDs and is received via a different CC of the set of CCs.

In some implementations of the UE, the processor, and the method described herein, the UE, the processor, and the method may further be configured to, capable of, or operable to identify a request for the UE to perform a handover procedure with a target serving cell based on the configuration, where the serving cell is the target serving cell, receive an indication of a CC of the set of CCs for synchronization with the target serving cell, and initiate a random access procedure to the target serving cell on the CC. In some implementations of the UE, the processor, and the method described herein, the UE, the processor, and the method may further be configured to, capable of, or operable to receive a message indicating a CC of the set of CCs for monitoring for a paging downlink control information (DCI), and monitor for the paging DCI on the CC. In some implementations of the UE, the processor, and the method described herein, the message includes a medium access control (MAC) control element (MAC-CE).

In some implementations of the UE, the processor, and the method described herein, the set of downlink channels include a set of physical downlink shared channels (PDSCHs) carrying a same transport block (TB), and the UE, the processor, and the method may further be configured to, capable of, or operable to receive each PDSCH of the set of PDSCHs via a different CC of the set of CCs. In some implementations of the UE, the processor, and the method described herein, the UE, the processor, and the method may further be configured to, capable of, or operable to receive a DCI via a CC of the set of CCs, where the DCI schedules the set of PDSCHs. In some implementations of the UE, the processor, and the method described herein, the UE, the processor, and the method may further be configured to, capable of, or operable to receive a set of DCI scheduling the set of PDSCHs, where each DCI of the set of DCI is received via the different CC of the set of CCs.

In some implementations of the UE, the processor, and the method described herein, the UE, the processor, and the method may further be configured to, capable of, or operable to transmit each physical uplink shared channel (PUSCH) of a set of PUSCHs carrying a same TB via a different CC of the set of CCs. In some implementations of the UE, the processor, and the method described herein, the UE, the processor, and the method may further be configured to, capable of, or operable to receive a DCI via a CC of the set of CCs, where the DCI schedules the set of PUSCHs. In some implementations of the UE, the processor, and the method described herein, the UE, the processor, and the method may further be configured to, capable of, or operable to receive a set of DCI scheduling the set of PUSCHs, where each DCI of the set of DCI is received via the different CC of the set of CCs. In some implementations of the UE, the processor, and the method described herein, each CC of the set of CCs is configured with one of an uplink-only configuration, a downlink-only configuration, or an uplink-and-downlink configuration.

An NE (e.g., a base station) for wireless communication is described. The NE may be configured to, capable of, or operable to perform one or more operations as described herein. For example, the NE may be configured to, capable of, or operable to transmit a configuration for a serving cell, where the serving cell is associated with a set of CCs, and where the configuration indicates at least one PCID associated with the serving cell, and transmit wireless communication via a set of downlink channels associated with the set of CCs and based on the at least one PCID.

A processor (e.g., a standalone processor chipset, or a component of a NE) for wireless communication is described. The processor may be configured to, capable of, or operable to perform one or more operations as described herein. For example, the processor may be configured to, capable of, or operable to transmit a configuration for a serving cell, where the serving cell is associated with a set of CCs, and where the configuration indicates at least one PCID associated with the serving cell, and transmit wireless communication via a set of downlink channels associated with the set of CCs and based on the at least one PCID.

A method performed or performable by an NE (e.g., a base station) for wireless communication is described. The method may include transmitting a configuration for a serving cell, where the serving cell is associated with a set of CCs, and where the configuration indicates at least one PCID associated with the serving cell, and transmitting wireless communication via a set of downlink channels associated with the set of CCs and based on the at least one PCID.

In some implementations of the NE, the processor, and the method described herein, the NE, the processor, and the method may further be configured to, capable of, or operable to share a same frame timing, a same SFN, and a same HARQ entity among the set of CCs. In some implementations of the NE, the processor, and the method described herein, the configuration indicates that the at least one PCID is associated with the set of CCs, and the NE, the processor, and the method may further be configured to, capable of, or operable to transmit at least one SSB of the serving cell via at least one CC of the set of CCs, where the at least one SSB is associated with the at least one PCID. In some implementations of the NE, the processor, and the method described herein, the at least one PCID includes a set of PCIDs, and where each PCID of the set of PCIDs is associated with a different CC of the set of CCs. In some implementations of the NE, the processor, and the method described herein, the NE, the processor, and the method may further be configured to, capable of, or operable to transmit a set of SSBs, where each SSB of the set of the SSBs is associated with a different PCID of the set of PCIDs and is transmitted via a different CC of the set of CCs.

In some implementations of the NE, the processor, and the method described herein, the NE, the processor, and the method may further be configured to, capable of, or operable to transmit a request for a UE to perform a handover procedure with a target serving cell based on the configuration, where the serving cell is the target serving cell, and transmit an indication of a CC of the set of CCs for synchronization with the target serving cell. In some implementations of the NE, the processor, and the method described herein, the NE, the processor, and the method may further be configured to, capable of, or operable to transmit a message indicating a CC of the set of CCs for monitoring for a paging DCI, and transmit the paging DCI via the CC. In some implementations of the NE, the processor, and the method described herein, the message includes a medium access control MAC-CE.

In some implementations of the NE, the processor, and the method described herein, the set of downlink channels include a set of PDSCHs carrying a same TB, and the NE, the processor, and the method may further be configured to, capable of, or operable to transmit each PDSCH of the set of PDSCHs via a different CC of the set of CCs. In some implementations of the NE, the processor, and the method described herein, the NE, the processor, and the method may further be configured to, capable of, or operable to transmit a DCI via a CC of the set of CCs, where the DCI schedules the set of PDSCHs. In some implementations of the NE, the processor, and the method described herein, the NE, the processor, and the method may further be configured to, capable of, or operable to transmit a set of DCI scheduling the set of PDSCHs, where each DCI of the set of DCI is transmitted via the different CC of the set of CCs. In some implementations of the NE, the processor, and the method described herein, the NE, the processor, and the method may further be configured to, capable of, or operable to receive each PUSCH of a set of PUSCHs carrying a same TB via a different CC of the set of CCs. In some implementations of the NE, the processor, and the method described herein, the NE, the processor, and the method may further be configured to, capable of, or operable to transmit a DCI via a CC of the set of CCs, where the DCI schedules the set of PUSCHs. In some implementations of the NE, the processor, and the method described herein, the NE, the processor, and the method may further be configured to, capable of, or operable to transmit a set of DCI scheduling the set of PUSCHs, where each DCI of the set of DCI is transmitted via the different CC of the set of CCs. In some implementations of the NE, the processor, and the method described herein, each CC of the set of CCs is configured with one of an uplink-only configuration, a downlink-only configuration, or an uplink-and-downlink configuration.

### BRIEF DESCRIPTION OF THE DRAWINGS

FIG. 1 illustrates an example of a wireless communications system in accordance with aspects of the present disclosure.

FIGS. 2-4 illustrate example aggregated component carrier (CC) configurations, in accordance with aspects of the present disclosure.

FIGS. 5-8 illustrate an example of information element (IE) contents, in accordance with aspects of the present disclosure.

FIG. 9 illustrates an example initial bandwidth part (BWP) configuration, in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

In a wireless communications system, a UE and a NE (e.g., a base station, gNB) may support wireless communication (e.g., reception and/or transmission of wireless communication) via an over-the-air interface as part of a radio access network (RAN). In some examples, a UE may support carrier aggregation (CA), where the UE communicates via two or more component carriers (CCs) simultaneously. CA increases bandwidths available for communication, thereby enabling much higher data rates than those achievable by single carriers. In conventional CA implementations, each CC corresponds to a distinct serving cell such that the UE is configured with multiple serving cells, with one cell designated as a primary cell (PCell) and one or more additional cells designated as secondary cells (SCells). Frame timing and system frame number (SFN) are aligned across cells that can be aggregated, or an offset in multiples of slots between a PCell/a primary secondary cell (PSCell) and an SCell is configured to the UE. Particular functions, such as radio link monitoring and control channel (e.g., physical uplink control channel (PUCCH)) transmissions, are assigned to the PCell or, in some cases, to a CC dedicated for the function. Additionally, in both uplink and downlink, there is one hybrid automatic repeat request (HARQ) entity per serving cell, and a transport block (TB) and its potential HARQ retransmissions are mapped to a single serving cell.

Additionally, or alternatively, a UE may be configured with one or more bandwidth parts (BWPs) for a serving cell. A BWP may be defined as a set of contiguous resource blocks (RBs) configured inside a channel bandwidth of a serving cell. In a serving cell configured with multiple CCs for CA, each CC may have a corresponding BWP within the CC. BWPs enable dynamic allocation of wide carrier bandwidths to improve efficiency in resource utilization and to reduce power consumption. For instance, a UE may operate in a relatively narrow BWP to maintain low power consumption and can switch to a wider BWP when larger amounts of data are scheduled. For each serving cell, an NE can configure up to four downlink (DL) BWPs, including one initial DL BWP, and up to four uplink (UL) BWPs, including one initial UL BWP. While multiple BWPs can be configured, only one DL BWP and one UL BWP can be active (e.g., used for transmission/reception) at a time. Additionally, BWPs can be configured on a device-specific basis according to a device's capabilities. An initial BWP of a serving cell refers to a BWP in which a UE can monitor for paging messages and/or search for a synchronization signal block (SSB) to use for initial access to the serving cell. A UE operating in an idle or inactive mode can camp on a serving cell and monitor for paging messages in the initial BWP of the serving cell. A UE connected to a serving cell (e.g., operating in a connected mode) may initiate a random access procedure with a target cell to connect to the target cell, and subsequently switches from an active BWP of the serving cell to an initial BWP of the target cell in order to receive an SSB from the target cell.

Existing CA and BWP frameworks, however, face limitations in terms of energy efficiency and flexibility, particularly as networks evolve towards energy-consuming higher frequency bands and wider bandwidths. While wide bandwidths provide improved data throughput and reduced latency, operating in such wide bandwidths can be sluggish and consume significant amounts of power. The rigid structure of conventional CA implementations (e.g., by designation of PCells and SCells, and by limiting each serving cell to correspond to a single CC), coupled with restrictions in BWP configurations, can hamper a network's ability to fine-tune resource allocations and adapt to diverse user requirements within wideband carriers. For instance, relying on a single PCell for critical functions like paging and system information delivery may create bottlenecks and single points of failure in certain scenarios. If radio link failure (RLF) occurs or a link quality of the PCell degrades, a UE may go through a lengthy layer-3 (L3) procedure (e.g., radio resource control (RRC) re-establishment, PCell-to-SCell change, handover) to restore network access, causing delays and impacting service continuity. Further, current systems struggle to dynamically adapt to changing traffic loads and channel conditions across multiple carriers. With only one initial BWP per serving cell, available random access resources for UEs attempting to connect to a serving cell are limited. The process of activating or deactivating different BWPs and/or CCs (e.g., SCells) can involve significant signaling overhead and latency, which may not be ideal for rapidly changing network environments. Moreover, as a separate HARQ entity exists per serving cell, a TB cannot be scheduled across different CCs for different transmission occasions. This constraint of mapping TBs to individual component carriers and maintaining separate HARQ entities for each serving cell can impede potential benefits of carrier aggregation, such as improved frequency diversity and reduced latency.

The described techniques provide methods and techniques for exploiting wideband carriers to enable flexible and energy-efficient serving cell configurations. According to the present disclosure, a serving cell is configured with a set of two or more CCs. A UE receives a configuration for the serving cell, which indicates at least one physical cell identity (PCID) associated with the serving cell and the set of CCs. In some examples, the configuration indicates a single PCID which is shared among all CCs of the set of CCs, while in other examples, the configuration indicates multiple PCIDs and each CC corresponds to a different PCID. One or more of the CCs may be allocated (e.g., assigned, dedicated) for a particular function, which may be indicated to the UE by an NE associated with the serving cell. For instance, the UE may receive a MAC-CE indicating a CC for monitoring for paging DCI and acquiring or re-acquiring system information (SI), a CC for performing a random access procedure, or the like. The UE can communicate (e.g., transmit, receive) TBs across multiple CCs simultaneously. In some implementations, the UE receives one or more downlink control information (DCI) messages, via one or more CCs of the set of CCs, that schedule a set of downlink messages (e.g., physical downlink shared channel (PDSCH) transmissions) on a subset of CCs of the set of CCs. The DCI message(s) may be received via a same CC. Alternatively, each DCI may be received via a respective CC, where each DCI schedules a respective downlink message on the respective CC. The same techniques can be applied for uplink messages (e.g., physical uplink shared channel (PUSCH) messages).

Additionally, or alternatively, the serving cell is configured with a set of two or more initial BWPs, such that initial access UEs can be distributed across a wideband carrier of the serving cell. In some examples, each initial BWP is associated with at least one respective CC of the set of CCs. Each initial BWP may be configured as an uplink-only initial BWP, a downlink-only initial BWP, or an uplink-and-downlink initial BWP. Uplink-only initial BWPs and/or uplink-and-downlink initial BWPs may be configured for random access procedures, while downlink-only initial BWPs and/or uplink-and-downlink initial BWPs may be configured for monitoring for paging messages (e.g., paging DCI). In some examples, one initial BWP may be designated as a default initial BWP and the remaining initial BWPs may be considered non-default initial BWPs. The UE receives an indication of the set of initial BWPs, monitors for paging messages in an initial BWP of the set of initial BWPs, and selects an initial BWP of the set of initial BWPs (e.g., the same initial BWP or a different initial BWP) for synchronizing with the serving cell and performing a random access procedure. For instance, the UE can receive a system information block (SIB) via a default initial BWP that indicates parameters for the default initial BWP and, in some cases, parameters for one or more non-default initial BWPs. In some examples, the UE receives one or more additional SIBs indicating additional parameters for the non-default initial BWP(s), where the additional SIB(s) can be received via the default initial BWP or via a non-default initial BWP to which the additional SIB corresponds. In some implementations, each initial BWP is configured with a respective random access channel (RACH) configuration including a set of RACH occasions and a RACH periodicity, and different initial BWPs may have different RACH periodicities.

The described techniques support increased data throughput and frequency diversity associated with operation in wide bandwidths while reducing energy consumption and improving communications efficiency. For example, by implementing the techniques described herein, available frequency resources of multiple CCs can be utilized quickly and efficiently, which can reduce transmission and reception times of devices in a network and conserve power. Aggregating multiple CCs under a single serving cell reduces signaling overhead and simplifies control plane operations compared to conventional CA approaches. Additionally, the techniques described herein enable dynamic indication of CCs and/or BWPs for particular functions (e.g., paging, random access) and efficient switching between CCs and BWPs by using lightweight signaling such as MAC-CEs. This streamlined architecture allows for flexible allocations of frequency resources across different frequency bands, enabling rapid adaptation to changing traffic conditions and user demands. Further, the flexibility to associate one or more different PCIDs with different CCs within a single serving cell enables more diverse cell planning and interference management in dense network deployments.

The described techniques also facilitate load balancing across the aggregated CCs. By configuring multiple initial BWPs across aggregated CCs, a network can distribute broadcast channels/signals and uplink channels/signals related to initial access procedures (e.g., synchronization, random access) across a bandwidth of a wideband carrier, thereby avoiding congestion, improving efficiency in spectrum utilization, reducing an always-on time of NEs in the network, and conserve energy. Additionally, by configuring multiple initial BWPs with RACH resources and different RACH periodicities, an increased quantity of UEs can perform initial access without increasing delays or overhead. Communicating a same TB across multiple CCs enables exploitation of frequency diversity, which improves reliability and reduces latency, without compromising energy efficiency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

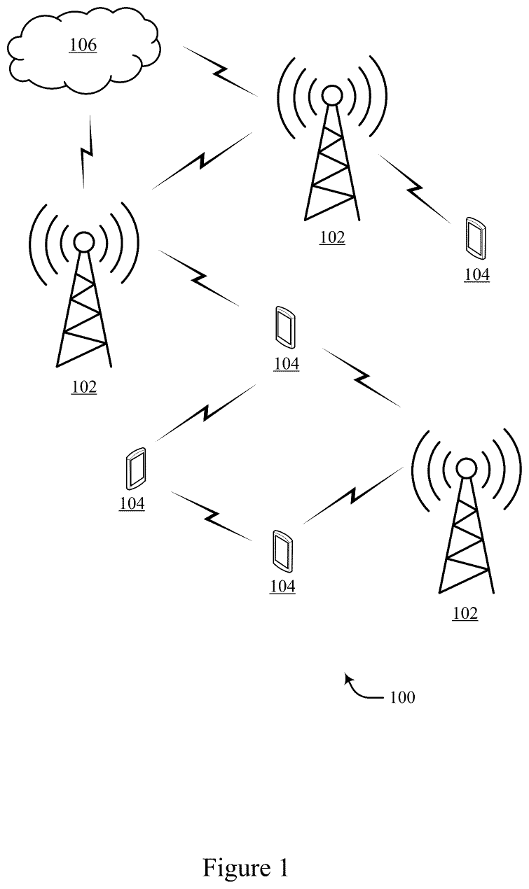

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., y=0) may be associated with a first subcarrier spacing (e.g., 15 kHz) and a normal cyclic prefix. In some implementations, the first numerology (e.g., y=0) associated with the first subcarrier spacing (e.g., 15 kHz) may utilize one slot per subframe. A second numerology (e.g., y=1) may be associated with a second subcarrier spacing (e.g., 30 kHz) and a normal cyclic prefix. A third numerology (e.g., y=2) may be associated with a third subcarrier spacing (e.g., 60 kHz) and a normal cyclic prefix or an extended cyclic prefix. A fourth numerology (e.g., y=³) may be associated with a fourth subcarrier spacing (e.g., 120 kHz) and a normal cyclic prefix. A fifth numerology (e.g., y=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., y=⁰, y=1, y=2, y=³, y=⁴) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., y=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A slot may refer to a basic time unit for scheduling in the wireless communications system 100. A slot includes a numerical quantity of symbols (e.g., 14 symbols or 12 symbols). A duration of a slot depends on a subcarrier spacing (SCS). An RB may refer to a unit of resources allocated in the frequency domain. An RB includes multiple consecutive subcarriers (e.g., 12 consecutive subcarriers) in the frequency domain and spans one slot in the time domain. In some examples, a size of an RB in the frequency domain may be fixed (e.g., 180 kHz, regardless of the subcarrier spacing). A RE may include one subcarrier during one symbol interval, where an RB includes a numerical quantity of resource elements, depending on the numerical quantity of symbols in a slot.

The UE 104 and the NE 102 can exchange (e.g., transmit and/or receive) signaling using one or more communication links. For example, the UE 104 receives signaling, including control information and/or data, from the NE 102 via a downlink communication link, while the NE 102 receives signaling, including control information and/or data, from the UE 104 via an uplink communication link. In some examples, a UE 104 can transmit an uplink transmission, which can include control signaling and/or data (e.g., PUSCH), to the NE 102 via the uplink communication link. A PUSCH transmission may include data and, optionally, uplink control information (UCI). A NE 102 may transmit signaling to the UE 104 scheduling one or more time-frequency resources for the PUSCH transmission, including one or more RBs and symbols within a slot or multiple slots. For example, the NE 102 may dynamically schedule the PUSCH transmission using a DCI message on a downlink control channel (e.g., a physical downlink control channel (PDCCH), or semi-statically schedule the PUSCH transmission using RRC signaling. In some examples, the DCI message may be transmitted within a control resource set (CORESET), which is a set of time-frequency resources of the downlink control channel.

A cell may refer to a radio access node in communication with an NE 102 or including an NE 102. A cell may have a coverage area, which is a geographic area in which the cell may provide wireless connectivity to devices within. Different cells may operate on defined frequencies or frequency bands, referred to as subcarriers. In some examples, a UE 104 may establish a wireless connection with a cell, and subsequently that cell may be referred to as a serving cell of the UE 104.

The UE 104 may communicate with the NE 102 of the serving cell, which may be referred to as a serving base station or a serving NE 102. The UE 104 can be mobile and may travel outside of a coverage area of the serving cell (e.g., to a coverage area of a target cell), which may cause disruption in service for the UE 104. Thus, the UE 104, the serving cell (e.g., the serving NE 102), and the target cell (e.g., an NE 102 associated with the target cell, referred to as a target NE 102) can coordinate a handover procedure from the serving cell (also referred to as a source serving cell) to the target cell. In some examples, the handover procedure includes a serving cell, the UE 104, or both monitoring one or more measurements, including signal strength measurements and signal quality measurements, to determine when to perform the handover procedure. When the measurements satisfy a threshold value, the network (e.g., the NE 102) selects a target cell and initiates a handover procedure via control signaling. For example, the UE 104 can receive, from the serving cell, RRC signaling including a configuration for the target cell, the target cell and the UE 104 may exchange synchronization signaling, and the serving cell may transmit a MAC-CE triggering a switch between the serving cell and the target cell. In response to the MAC-CE triggering the switch between the serving cell and the target cell, the UE 104 can initiate a random access procedure.

In some examples, one or more devices in the wireless communications system 100 support CA for multiple CCs. A CC (e.g., a communication channel in the frequency domain) may be associated with characteristics such as a frequency range, a bandwidth, a data rate, throughput, and the like, and different CCs can have different such characteristics. A UE 104 that is capable of simultaneously transmitting and/or receiving on multiple CCs may be configured with a CA configuration, where a set of configured CCs correspond to a serving cell. A CC may be configured for uplink communications, downlink communications, or both, and a quantity of CCs configured for UL may be different from a quantity of CCs configured for DL. Additionally, each CC may be configured with a corresponding BWP, such as an initial BWP in accordance with the techniques described herein. The CCs in the set can be contiguous or non-contiguous with one another and can be in the same frequency band or in different frequency bands. Each CC may be used for frequency domain duplexed (FDD) communications, time domain duplexed (TDD) communications, or both. In FDD communications, each downlink or uplink frequency channel is individually referred to as a CC and is assigned a distinct physical carrier index, whereas in TDD mode each frequency channel with downlink and uplink partitions in time is designated as a CC and is assigned a distinct physical carrier index.

In 5G NR and earlier releases, each CC corresponds to a respective serving cell, such that the UE 104 is configured with multiple serving cells. Of the multiple serving cells, the serving cell to which the UE 104 initially connects may be designated as the PCell. The CC associated with the PCell may be referred to as a primary carrier or primary CC. The UE 104 may transmit all uplink data via the PCell/primary carrier, and the PCell may be the only serving cell used for communication of control signaling and user data. After connecting to the PCell, the UE 104 may connect to one or more additional serving cells, referred to as SCells, secondary carriers, or secondary CCs. SCells may include or be an example of downlink-only CCs or supplemental UL (SUL) CCs and can be added to a CA configuration as needed, e.g., based on data rates. When a UE 104 uses multiple frequency bands or cells concurrently in CA, a PCell manages control functions and basic services, while SCells provide additional bandwidth and capacity for increasing signaling throughput. Handover procedures and/or serving cell change procedures when CA is configured involve changing a PCell and an SCell (e.g., from source PCells/SCells to target PCells/SCells), as well as release or addition of additional SCells, when applicable.

Serving cell configurations may be device-specific. For example, a first UE 104 may have a different PCell than a second UE 104. Frame timing and system frame numbers (SFNs) are aligned across aggregated cells (e.g., of the multiple serving cells), or an offset may be configured (e.g., a multi-slot offset) between a PCell/PSCell and an SCell. The offset may be configured as part of the CA configuration. In both uplink and downlink, each serving cell is associated with one independent HARQ entity per serving cell, and a TB and its potential HARQ retransmissions are mapped to a single serving cell. Additionally, in CA, one or more CCs may be activated (e.g., used for transmission/reception) or deactivated (e.g., not used for transmission/reception). For instance, the UE 104 may receive MAC signaling including a bitmap, where each bit indicates whether a corresponding CC/serving cell (e.g., SCell) should be activated or deactivated.

In 5G NR, the following common search space (CSS) sets are used for SIB Type1 (SIB1) and other system information (SI) delivery, random access procedures, small data transmission (SDT) procedures, paging, and paging early indication:
a Type0-PDCCH CSS set on the primary cell of the MCG configured by pdcch-ConfigSIBI in Master Information Block (MIB), or by searchSpaceSIB1 in PDCCH-ConfigCommon, or by searchSpaceZero in PDCCH-ConfigCommon for a DCI format 1_0 with CRC scrambled by a SI-RNTI.
a Type0A-PDCCH CSS set configured by searchSpaceOtherSystemInformation in PDCCH-ConfigCommon for a DCI format 1_0 with CRC scrambled by a SI-RNTI on the primary cell of the MCG.
a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell.
a Type1A-PDCCH CSS set configured by sdt-SearchSpace in PDCCH-ConfigCommon for a DCI format with CRC scrambled by a C-RNTI or a CS-RNTI on the primary cell.
a Type2-PDCCH CSS set configured by pagingSearchSpace in PDCCH-ConfigCommon for a DCI format 1_0 with CRC scrambled by a P-RNTI on the primary cell of the MCG.
a Type2A-PDCCH CSS set configured by pei-SearchSpace in pei-ConfigBWP for a DCI format 2_7 with CRC scrambled by a PEI-RNTI on the primary cell of the MCG.

In 5G NR, some operating frequency bands such as n41 (2496-2690 MHz), n48 (3550-3700 MHz), and n77 (3300-4200 MHz) in FR1, can accommodate a base station channel bandwidth up to 100 MHz with a transmission bandwidth of up to 273 RBs. In 6G RAN, it is anticipated to add a centimeter wave spectrum (e.g., 7-15 GHz) to operating frequency bands and to support an even larger carrier bandwidth than in 5G. A carrier with bandwidths in these ranges may be referred to as a wideband carrier, which may be defined as a carrier 100 MHz or greater with a transmission bandwidth of 273 RBs or larger. In wideband carrier operations, techniques such as BWP configuration and CA configuration can enable portions of a wideband carrier to be allocated among devices or cells in a network, thereby avoiding excessive energy consumption associated with communicating over wide bandwidths.

In 5G NR, for example, a UE 104 may be configured with both UE-specific BWPs and a set of CCs for CA. In such scenarios, each CC configured in a set of CCs for CA may be associated with (e.g., allocated, assigned) one or more BWPs. Additionally, BWPs may be configured on a UE-specific basis. A BWP may be defined as an allocation of resources (e.g., of a carrier) in the frequency domain. In a serving cell, a UE 104 may be configured with up to four DL BWPs, including an initial downlink BWP for reception, and up to four uplink BWPs, including an initial UL BWP for transmission. Each BWP has a corresponding size (e.g., bandwidth) and numerology, including an SCS, a symbol duration, and a CP. Each DL BWP is configured with at least one CORSET with a UE-specific search space and a BWP in a PCC may be configured with at least one CORESET with a common search space (CSS). For each DL BWP of a set of DL BWPs associated with a PCell, the UE 104 may be configured with one or more CORESETs for every type of CSS set. The UE 104 does not expect to be configured without a CSS set on the PCell on an active DL BWP.

In some examples, a DCI format for DCI received by the UE 104 may be configured with a BWP indicator field, a value of which indicates an active DL BWP (e.g., of a configured set of DL BWPs) for DL receptions. Additionally, or alternatively, the value of the BWP indicator field may indicate an active UL BWP (e.g., of a configured set of UL BWPs) for UL transmissions. The UE 104 receives PDCCH and PDSCH in an active DL BWP according to a configured SCS and CP length for the DL BWP. The UE 104 transmits PUCCH and PUSCH in an active UL BWP according to a configured SCS and CP length for the UL BWP. Additionally, the UE 104 may not monitor for PDCCH when the UE 104 performs radio resource management (RRM) measurements over a bandwidth that is not within an active DL BWP for the UE 104. A UE 104 operating in an idle or inactive mode (e.g., RRC_IDLE, RRC_INACTIVE) may monitor for paging messages in an initial BWP of a PCell. A UE 104 operating in a connected mode (e.g., RRC_CONNECTED) may monitor for an SI change indication in any paging occasion (PO) of a PCell at least once per modification period, such as if the UE 104 is provided with CSS sets including pagingSearchSpace, searchSpaceSIB1 and searchSpaceOtherSystemInformation, on an active BWP.

In 5G NR, only one BWP can be active for a particular direction of communication (e.g., UL, DL) at a time. A UE 104 can switch between BWPs/CCs by activating or deactivating a particular BWP/CC (e.g., based on signaling from an NE 102, such as DCI or RRC signaling, or based on expiry of a BWP timer at the UE 104), where an active BWP/CC refers to a BWP/CC used for communication (e.g., transmission, reception) and an inactive BWP/CC refers to a BWP/CC that is not being used for communication. Additionally, handover and cell change procedures involve switching from an active BWP of a source serving cell to an initial BWP of a target serving cell, and the UE 104 monitors for SSBs in the initial BWP of the target serving cell. If the UE 104 is not provided with an initial DL BWP configuration (e.g., by an NE 102 of the target serving cell), an initial DL BWP is defined by a location and quantity of a set of contiguous physical resource blocks (PRBs). Each PRB is associated with a respective index, and the set of contiguous PRBs starts at a PRB having a lowest index and ends at a PRB having a highest index among PRBs of a CORESET (e.g., for a Type0-PDCCH CSS set) after puncturing, if any. Additionally, the initial DL BWP may have an SCS and a CP for PDCCH reception in the CORESET (e.g., for the Type0-PDCCH CSS set).

If a UE 104 is configured with an SUL, when a random access procedure is to be performed in a serving cell, the UE 104 may select a CC from an SUL and a non-SUL for performing the random access procedure. The UE 104 initiates the random access procedure and, if physical random access channel (PRACH) occasions are not configured for an active UL BWP, the UE 104 switches from operating in the active UL BWP to an initial UL BWP. Additionally, if the serving cell is a special cell (SpCell) (i.e., a PCell of a master cell group (MCG) or a secondary cell group (SCG)), the UE 104 switches from operating in an active DL BWP to an initial DL BWP.

Alternatively, if PRACH occasions are configured for the active UL BWP, if the target serving cell is an SpCell, and if the active DL BWP does not have a same BWP identity as the active UL BWP, the UE 104 may switch the active DL BWP to a DL BWP with a same BWP identity as the active UL BWP. If the target serving cell is an SCell, the UE 104 stops a BWP inactivity timer associated with an active DL BWP of an SpCell (if running) and performs the random access procedure on the active DL BWP of the SpCell and the active UL BWP of the target serving cell. Upon reception of RRC (re-)configuration for BWP switching for a serving cell while a random access procedure associated with that serving cell is ongoing in a MAC entity, the MAC entity may stop the ongoing random access procedure and perform the BWP switching, and may initiate a subsequent random access procedure after performing the BWP switching.

According to implementations, one or more of the NEs 102 and the UEs 104 are operable to implement various aspects of the techniques described with reference to the present disclosure. For example, a UE 104 receives (e.g., from an NE 102) a serving cell configuration for a serving cell comprising multiple aggregated CCs. The serving cell configuration may include information related to synchronization and random access procedures for the aggregated CCs. For instance, the serving cell configuration may indicate at least one PCID associated with the serving cell. If the serving cell configuration indicates a single PCID, the PCID is associated with all CCs of the aggregated CCs. Alternatively, if the serving cell indicates multiple PCIDs, each PCID may correspond to a CC of the aggregated CCs. In some cases, the UE 104 may determine, based on receiving a serving cell configuration that indicates one PCID and multiple CCs, that the associated serving cell is an aggregated cell configured for CA.

The aggregated CCs in the serving cell may operate with the same frame timing, system frame number (SFN), and HARQ entity. This configuration allows for coordinated operation across the multiple CCs within a single serving cell. Additionally, the aggregated CCs may be associated with a same uplink timing advance (TA) value for uplink synchronization (e.g., between the UE 104 and the serving cell). Additionally, or alternatively, the aggregated CCs may be deployed in a same cell site or in different cell sites. In some cases, the aggregated CCs may be in the same and/or different frequency bands in frequency range (FR) 1 (410 MHz-7125 MHz), FR2 (24250 MHz-71000 MHz), or FR3 (7125 MHz-24250 MHz). The NE 102 may configure each CC with one of an uplink-only configuration, a downlink-only configuration, or an uplink-and-downlink configuration. In implementations, a quantity of HARQ processes in a HARQ entity of the serving cell increases with the quantity of aggregated CCs.

The UE 104 may receive one or more SSBs from the NE 102 via one or more of the aggregated CCs. Each CC, and thus each SSB, may be associated with a physical cell identity (PCID) (e.g., a same PCID or different PCIDs) indicated in the serving cell configuration. In some implementations, the UE 104 may receive multiple SSBs, where each SSB is associated with a different PCID and received via a different CC of the aggregated CCs. For example, the NE 102 may transmit at least one SSB on a frequency location of a synchronization raster. A synchronization raster may be a set of frequency locations where the UE 104 searches for an SSB during initial access.

Additionally, or alternatively, the NE 102 may transmit, to the UE 104, an indication of a set of initial BWPs of the serving cell. For example, the serving cell configuration can indicate a set of initial BWPs and/or a set of aggregated CCs that are configured for the serving cell. The NE 102 may configure each initial BWP with a respective numerology and size. Additionally, the NE 102 may configure each initial BWP as one of an uplink-only initial BWP, a downlink-only BWP, or an uplink-and-downlink initial BWP. In some examples, the NE 102 may configure one initial BWP of the set of initial BWPs as a default initial BWP, while the remaining initial BWPs are configured as non-default initial BWPs. In such examples, the NE 102 may dedicate the default initial BWP for SIB transmissions, SSB broadcasting, or other functions. The UE 104 receives, from the NE 102, the indication of the set of initial BWPs. The UE 104 then selects an initial BWP from the set of initial BWPs for monitoring for paging DCI from the serving cell (e.g., from the NE 102). In some examples, the UE 104 selects the initial BWP based on an identifier (ID) associated with the UE 104. The UE 102 may be capable of operating in any of the initial BWPs. That is, unlike conventional implementations, the UE 102 is not restricted to a particular initial BWP based on a capability of the UE 104 or other characteristics.

For example, the NE 102 may transmit SIB Type 1 (SIB1) via the default initial BWP and may transmit extended SIB1 (eSIB1) via the non-default initial BWPs. The SIB1 may carry parameters common to the set of initial BWPs, a limited amount of information associated with the non-default initial BWPs (e.g., a required minimum information to enable the UE 104 to receive SSBs/eSIBIs via non-default initial BWPs), and information (e.g., a RACH configuration) specific to the default initial BWP. For instance, the SIB1 may include an indication of frequency locations of other SSBs associated with the serving cell, CORESET and/or search space configurations for non-default initial BWPs, a RACH configuration for the default initial BWP, and so forth. The UE 104 may utilize the information in the SIB1 to receive eSIBI(s) in the non-default initial BWPs. Each eSIB1 may indicate respective additional parameters for a respective non-default initial BWP, such as the non-default initial BWP in which the eSIB1 was transmitted. By partitioning system information among the SIB1 and the eSIB1s, the SIB1 and eSIB1 payload sizes can be kept relatively small for broadcasting. Alternatively, the NE 102 may transmit SIB1s for each non-default initial BWP via the default initial BWP (e.g., along with the SIB1 for the default initial BWP). In some cases, the NE 102 may not designate a default initial BWP or non-default initial BWPs.

A RACH configuration includes a set of RACH occasions (e.g., RACH resources) and a RACH occasion periodicity. In some cases, each initial BWP is configured with a RACH configuration. Alternatively, or additionally, some initial BWPs (e.g., non-default initial BWPs) may not be associated with a RACH configuration. In some examples, a RACH configuration is transmitted to the UE 104 in the initial BWP to which the RACH configuration corresponds. Alternatively, the UE 104 can receive multiple RACH configurations for multiple initial BWPs via one initial BWP. For instance, the UE 104 may receive RACH configurations for non-default initial BWPs via the SIB1 received in the default initial BWP. The RACH resources and the RACH occasion periodicity can be different for each initial BWP, which enables the NE 102 to distribute initial access UEs 104 across the serving cell's bandwidth. In implementations, the NE 102 configures the default initial BWP with a shorter RACH occasion periodicity than non-default initial BWPs.

The UE 104 may be triggered to perform a random access procedure with the serving cell. For example, the UE 104 operating in a connected mode in a source serving cell may be instructed (e.g., by the NE 102) or may otherwise determine to initiate a handover or serving cell change to the serving cell, and may initiate the random access procedure in response. In such examples, the UE 104 receives an RRC message requesting a serving cell change for handover, where the RRC message may include or be an example of the serving cell configuration. Alternatively, the UE 104 operating in an idle or inactive mode may camp on the serving cell and may monitor an initial BWP-which may be associated with a respective CC—to receive paging messages from the NE 102, based on which the UE 104 initiates the random access procedure. When a serving cell change or handover is triggered, the UE 104 may receive the serving cell configuration from the serving cell.

In the serving cell, the UE 104 determines an initial BWP of a set of initial BWPs and, in some cases, a CC of a set of aggregated CCs, to use for each function of initial access (e.g., performing uplink synchronization with the serving cell, monitoring for paging messages, receiving emergency broadcast messages, and/or performing random access). In some cases, UE 104 determines the initial BWP(s) and the CC(s) based on receiving one or more indications from the NE 102. For example, the serving cell configuration may indicate a CC for uplink synchronization and random access. In some cases, the UE 104 can receive an indication of a dedicated random access resource (e.g., a PRACH preamble) for CFRA, where the dedicated random access resource is on the indicated CC. Additionally, or alternatively, the serving cell configuration indicates a CC and/or initial BWP for monitoring for paging messages, which may be different from the CC indicated for uplink synchronization and random access. As yet another example, the UE 104 may receive a MAC-CE indicating the CC for monitoring. The UE 104 may receive a search space configuration for paging DCI on the indicated CC.

In other cases, the UE 104 selects the initial BWP(s) and/or the CC(s) for monitoring for paging messages based on a UE ID associated with the UE 104. Additionally, or alternatively, if the serving cell configuration indicates a default initial BWP, the UE 104 selects the default initial BWP in which to monitor for the paging messages. In some cases, the UE 104 can perform random access in either the default initial BWP or a non-default initial BWP. In some implementations, the UE 104 selects an initial BWP for random access based on RACH configurations associated with the initial BWPs. For example, the UE 104 may monitor for paging DCI in a first initial BWP and may receive (e.g., via SIB1(s) received in the first initial BWP or a different initial BWP) RACH configurations for one or more of the initial BWPs. If the first initial BWP is associated with a RACH configuration, the UE 104 can initiate the random access procedure in the first initial BWP. Alternatively, if the first initial BWP does not have a corresponding RACH configuration, the UE 104 can switch to an initial BWP that does have a RACH configuration to perform the random access procedure. For instance, the first initial BWP may be a non-default initial BWP unaffiliated with a RACH configuration, and the UE 104 may switch to a default initial BWP with a RACH configuration to perform the random access procedure.

In implementations, the UE 104 selects a CC/initial BWP for performing random access based on available RACH occasions associated with the CC/initial BWP. When the random access procedure is triggered at the UE 104, the UE 104 considers RACH configurations associated with each initial BWP to determine, from among all available RACH occasions, an earliest-available RACH occasion in which the UE 104 can transmit a PRACH preamble (e.g., taking into account any BWP switching delays). The UE 104 selects the initial BWP associated with the earliest-available RACH occasion for performing the random access procedure. By enabling the UE 104 to perform random access in any of multiple initial BWPs, the described techniques reduce delays associated with initial access and avoid congestion if multiple UEs 104 attempt to access the serving cell at the same time. For example, the UE 104 can perform random access in an initial BWP (e.g., a default initial BWP) associated with a shorter RACH periodicity, and other UEs 104 camping on other initial BWPs (e.g., non-default initial BWPs) can also initiate random access procedures without delay.

Once connected to the serving cell (e.g., subsequent to random access), the UE 104 and the NE 102 may communicate (e.g., transmit, receive) uplink messages (e.g., PUSCH, PUCCH) and downlink messages (e.g., PDSCH, PDCCH) in one or more initial BWPs of one or more CCs. In some examples, a TB can be mapped to a single CC of the set of CCs, while in other examples, a TB can be mapped to multiple CCs of the set of CCs (e.g., a subset of CCs). Additionally the NE 102 may schedule the UE 104 with uplink or downlink transmissions using a single DCI transmitted via a single CC, or using multiple DCIs transmitted via the multiple CCs (e.g., the subset of CCs).

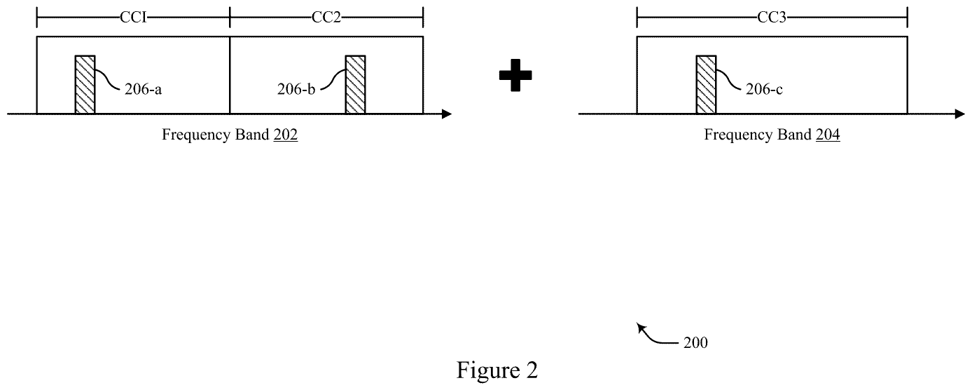

FIG. 2 illustrates an aggregated CC configuration 200 in accordance with aspects of the present disclosure. The aggregated CC configuration 200 may implement or be implemented by aspects of the wireless communications system 100. For example, an NE (e.g., an NE 102) may configure a serving cell according to the aggregated CC configuration 200 and may transmit a serving cell configuration to a UE (e.g., a UE 104) as described with reference to FIG. 1. The serving cell includes a set of CCs, such as a CC1 and a CC2 in a frequency band 202 and a CC3 in a frequency band 204.

The aggregated CC configuration 200 illustrates an example in which the serving cell and the set of CCs are associated with a single PCID, which is indicated to the UE in the serving cell configuration. The UE may determine that the serving cell is an aggregated serving cell (e.g., is comprised of aggregated CCs) based on the serving cell configuration indicating the PCID and the set of CCs. The UE can receive one or more SSBs from the NE via the set of CCs. The UE expects that the SSB(s) correspond to the indicated PCID, and uses the indicated PCID for communication on the CCs. That is, the UE uses the indicated PCID for cell-specific scrambling sequence generation and uplink synchronization with the serving cell.

In some implementations, the NE transmits the SSB(s) on only one CC of the set of CCs. In other implementations, as illustrated in FIG. 2, the NE transmits SSB(s) 206 of the serving cell on multiple CCs of the set of CCs. The SSBs 206 all correspond to (e.g., include) a same PCID (e.g., the indicated PCID). The aggregated CC configuration 200 includes an SSB 206-a on the CC1, an SSB 206-b on the CC2, and an SSB 206-c on the CC3. In some cases, the SSB 206-a, the SSB 206-b, and the SSB 206-c may be positioned at different frequency locations within their respective CCs. For example, the SSB 206-a, the SSB 206-b, and the SSB 206-c may be communicated (e.g., transmitted, received) on different frequency positions of a synchronization raster in different CCs, allowing each CC to be separately discoverable as a separate cell by a UE operating in an idle or inactive mode.

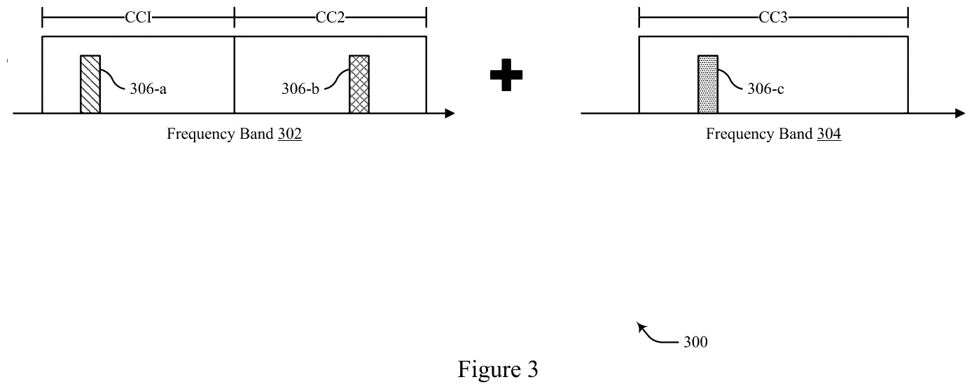

FIG. 3 illustrates an aggregated CC configuration 300 in accordance with aspects of the present disclosure. The aggregated CC configuration 300 may implement or be implemented by aspects of the wireless communications system 100. For example, an NE (e.g., an NE 102) may configure a serving cell according to the aggregated CC configuration 230 and may transmit a serving cell configuration to a UE (e.g., a UE 104) as described with reference to FIG. 1. The serving cell includes a set of CCs, such as a CC1 and a CC2 in a frequency band 302 and a CC3 in a frequency band 304.

The aggregated CC configuration 300 illustrates an example in which the serving cell and the set of CCs are associated with a set of PCIDs, which are indicated to the UE in the serving cell configuration. The UE identifies that the serving cell is an aggregated serving cell (e.g., is comprised of aggregated CCs) based on the serving cell configuration indicating multiple PCIDs for the serving cell and the set of CCs. Each CC is associated with a (different) respective PCID, such that the UE receives, from the NE, a (different) respective SSB via each CC. In the example of FIG. 3, the UE receives an SSB 306-a associated with a first PCID via the CC1, an SSB 306-b associated with a second PCID via the CC2, and an SSB 306-c associated with a third PCID via the CC 3. An idle or inactive mode UE can discover each CC separately based on the corresponding PCID.

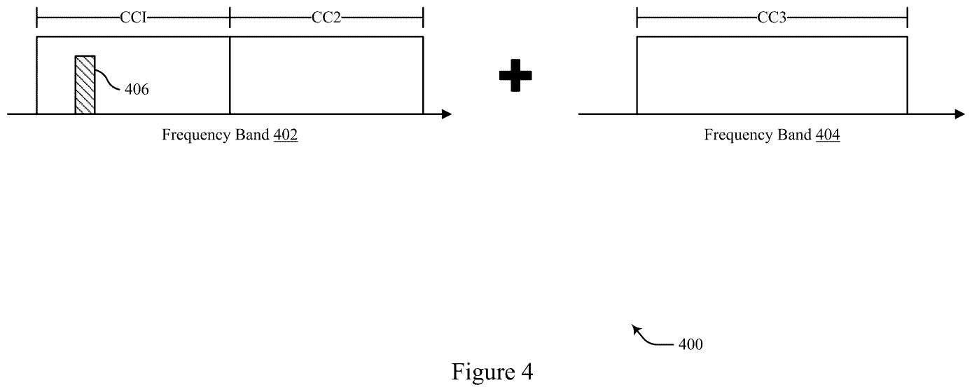

FIG. 4 illustrates an aggregated CC configuration 400 in accordance with aspects of the present disclosure. The aggregated CC configuration 400 may implement or be implemented by aspects of the wireless communications system 100. For example, an NE (e.g., an NE 102) may configure a serving cell according to the aggregated CC configuration 400 and may transmit a serving cell configuration to a UE (e.g., a UE 104) as described with reference to FIG. 1. The serving cell includes a set of CCs, such as a CC1 and a CC2 in a frequency band 402 and a CC3 in a frequency band 404.

The aggregated CC configuration 400 illustrates an example in which the serving cell and the set of CCs are associated with a single PCID, which is indicated to the UE in the serving cell configuration. The UE may determine that the serving cell is an aggregated serving cell (e.g., is comprised of aggregated CCs) based on the serving cell configuration indicating the PCID and the set of CCs.

In the example of FIG. 4, the NE transmits, to the UE, an SSB 406 on only one CC of the set of CCs (e.g., CC1). More specifically, the NE transmits the SSB 406 on a frequency position of a synchronization raster in CC1. The NE does not transmit any SSBs in either the CC2 or the CC3. Since there is no SBB transmission on any frequency position of the synchronization raster in the CC2 or the CC3, an idle mode UE cannot camp on the CC2 or the CC3. A connected mode UE may receive, from the NE, reference signals in the CC2 and/or the CC3 to enable the UE to acquire synchronization and timing information of the serving cell. For instance, the UE may receive a configuration for receiving tracking reference signals and/or measurement reference signals in the CC2 and/or the CC3.

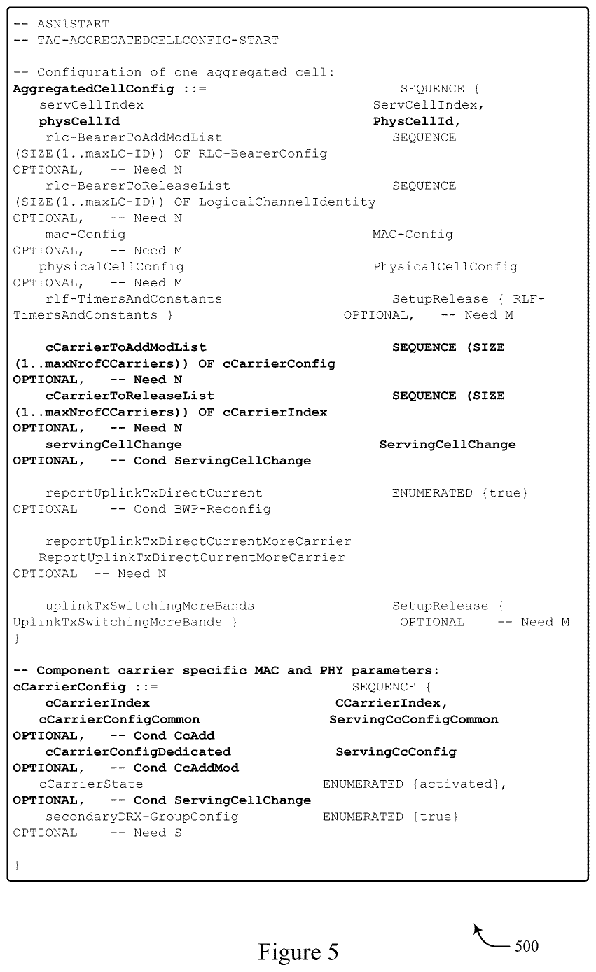

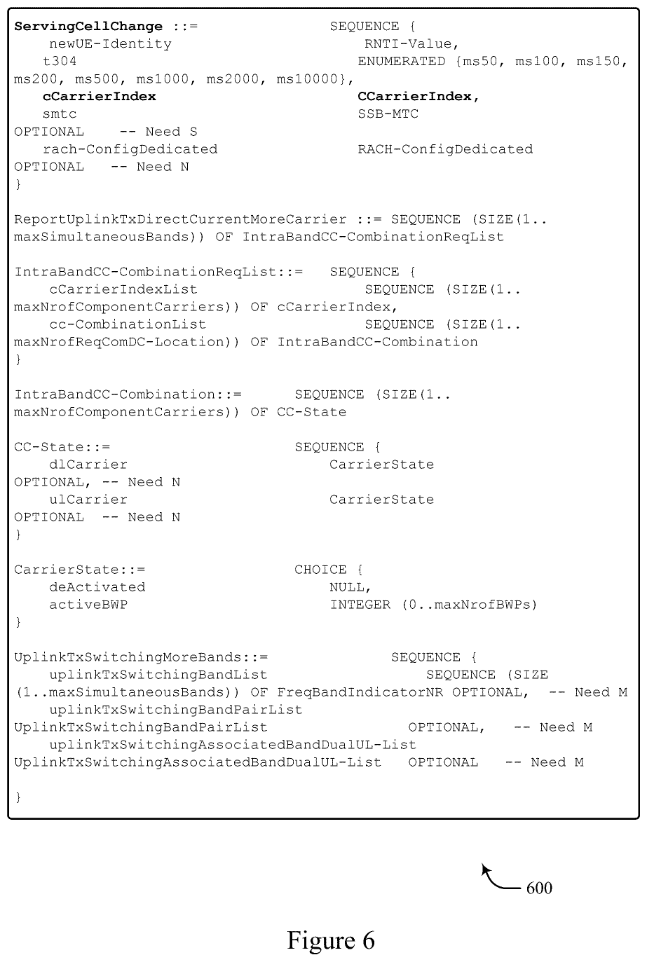

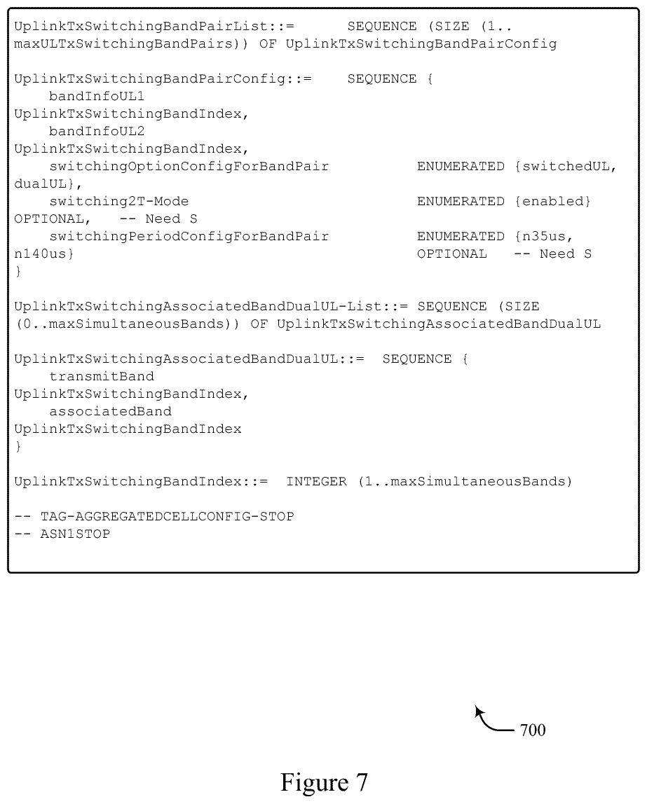

FIGS. 5, 6, and 7 illustrate information element (IE) contents 500, 600, and 700, respectively, for an IE used to configure a serving cell with multiple CCs, also referred to herein as an aggregated cell, in accordance with aspects of the present disclosure. For example, an NE may transmit, to a UE, a serving cell configuration that includes the IE with IE contents 500, 600, and 700. The IE may be defined as an AggregatedCellConfig IE used to configure an aggregated cell consisting of one MAC entity, a set of logical channels with associated radio link control (RLC) entities, and a set of two or more CCs.

The AggregatedCellConfig IE includes parameters such as servCellIndex, physCellId, and various configuration lists for bearers. In some cases, the IE may include MAC configuration parameters, physical cell configuration parameters, and radio link failure (RLF) timers and constants. The AggregatedCellConfig IE may also include fields for CC configurations, such as a parameter cCarrierConfig. cCarrierConfig indicates, for each CC of the set of CCs, an UL-only configuration, a DL-only configuration, or an UL-and-DL configuration. Additionally, the CC configuration fields can include cCarrierToAddModList and cCarrierToReleaseList. These fields may allow for the addition, modification, or release of CCs within the aggregated cell. Other IE fields can include uplink transmission switching configurations, such as a switching mode, a switching period duration, and parameters for configuring band pairs and associated bands for uplink transmission switching.

A servingCellChange field is included in the AggregatedCellConfig IE when a serving cell change (e.g., handover) is requested by the NE. The servingCellChange field may be used to configure parameters for synchronous reconfiguration to a target aggregated cell. These parameters may include a CC index (e.g., cCarrierIndex) of a CC of the target aggregated cell where the UE is to perform a random access procedure, a PCID of the target aggregated cell (e.g., physCellId), an SSB configuration of the target aggregated cell (e.g., smtc), and the like, among other examples.

The IE may further include an indication cCarrierState for a CC, where a carrier state indicates whether the CC is active (e.g., activated) or inactive (e.g., deactivated). If a CC is indicated in servingCellChange for synchronization to the target aggregated cell, cCarrierState may be set to “activated” for that CC.

Further details of information included in the IE are shown in Tables 1-6 below.

TABLE 1
CC-State field descriptions

dlCarrier
Indicates DL carrier activation state for this carrier and the
related active BWP Index, if activated.
ulCarrier
Indicates UL carrier activation state for this carrier and the
related active BWP Index, if activated.

TABLE 2
AggregatedCellConfig field descriptions

mac-Config
MAC parameters applicable for the aggregated cell.
physicalCellConfig
Physical layer parameters applicable for the aggregated cell.
rlc-BearerToAddModList
Configuration of the MAC Logical Channel, the corresponding RLC entities and association with radio bearers.
rlf-TimersAndConstants
Timers and constants for detecting and triggering cell-level radio link failure.
servingCellChange
Parameters for the synchronous reconfiguration to the target aggregated cell. cCarrierIndex indicates the component
carrier of the target aggregated cell, where the UE initiates a random access procedure. If this fields exist, physCellId
indicates a physical cell identity of the target aggregated cell. smtc indicates the SSB periodicity/offset/duration
configuration of the target aggregated cell and is based on the timing reference of a source aggregated cell.
reportUplinkTxDirectCurrent
Enables reporting of uplink Direct Current location information upon BWP configuration and reconfiguration. This field
is only present when the BWP configuration is modified, or any serving component carrier is added or removed. This
field is absent in the IE AggregatedCellConfig when provided as part of RRCSetup message.
reportUplinkTxDirectCurrentMoreCarrier
Enables reporting of uplink Direct Current location information when the UE is configured with intra-band CA. This field
is absent in the IE AggregatedCellConfig when provided as part of RRCSetup message. The UE only reports the
uplink Direct Current location information that are related to the indicated cc-CombinationList. The network does not
include carriers which locate in DL only spectrum.
rlc-BearerToReleaseList
List of the RLC entities and the corresponding MAC Logical Channels to be released.
cCarrierToAddModList
List of component carriers to be added or modified.
cCarrierToReleaseList
List of component carriers to be released.
cCarrierConfig
Parameters for the DL only, UL only, or UL/DL component carrier.
cCarrierState
Indicates whether this component carrier shall be considered to be in activated state upon configuration. If this
component carrier is indicated in ServingCellChange for synchronization to the target aggregated cell, it shall be set to
‘activated.
secondaryDRX-GroupConfig
Indicate whether the component carrier belongs to the secondary DRX group. All component carriers in the secondary
DRX group shall belong to one Frequency Range and all component carriers in the default DRX group shall belong to
another Frequency Range. If drx-ConfigSecondaryGroup is configured, the field is optionally present. The network
always includes the field if the field was previously configured for this component carrier and the component carrier
remains in the secondary DRX group. Removal of an individual component carrier from the secondary DRX group is
supported by using an component carrier release and addition. Otherwise, if drx-ConfigSecondaryGroup is not
configured, the field is absent and the UE shall release the field. The UE shall also release the field if drx-
ConfigSecondaryGroup is released without including cCarrierToAddModList.
uplinkTxSwitchingMoreBands
Indicates UL band list, band pair list and other configurations for ULTx switching.

TABLE 3
ReportUplinkTxDirectCurrentMoreCarrier field descriptions

IntraBandCC-Combination
Indicates the state of the carriers and BWPs indexes of the carriers
in a CC combination, each carrier in this combination corresponds
to an entry in cCarrierIndexList with same order. This IE
shall have the same size as cCarrierIndexList.
IntraBandCC-CombinationReqList
Indicates the list of the requested carriers/BWPs combinations
for an intra-band CA component.
cCarrierIndexList
indicates the list of component carrier index for an intra-
band CA component.

TABLE 4
UplinkTxSwitchingMoreBands field descriptions

uplinkTxSwitchingBandList
Indicates the NR frequency band number of the UL bands for
UL Tx switching. If the UE needs to determine location of
switching period as specified in TS 38.101-1, the UE considers
that the bands are listed in decreasing order of priority, i.e.
the first/leftmost entry corresponds to the band with the highest
priority, the next entry corresponds to the band with the second
highest priority, and so on. The last entry corresponds the
band with the lowest priority.
uplinkTxSwitchingBandPairList
Indicates the band pairs involved in UL Tx switching, as well as
the per band pair configurations.
uplinkTxSwitchingAssociatedBandDualUL-List
Indicates the associated band for the transmitting band indicated
by transmitBand which the transmitting carrier(s) is on as specified
in TS 38.214, clause 6.1.6. The network ensures that each band pair
of a transmitting band and an associated band supports the
dualUL switching option.
UplinkTxSwitchingBandIndex
The value n indicates the band included at the n-th entry of
uplinkTxSwitchingBandList.

TABLE 5
UplinkTxSwitchingBandPairConfig field descriptions

bandInfoUL1, bandInfoUL2
Indicates the band index for a band pair. The value n indicates
the band included at the n-th entry of uplinkTxSwitchingBandList.
switching2T-Mode
Indicates 2Tx-2Tx switching mode is configured to the band pair.
If this field is absent when uplink Tx switching is configured,
it is interpreted that 1Tx-2Tx/1Tx-1Tx UL Tx switching is
configured as specified in TS 38.214.
switchingOptionConfigForBandPair
Indicates the switching option for the band pair as specified
in TS 38.214, clause 6.1.6.
switchingPeriodConfigForBandPair
Indicates the value of switching period for the band pair.
Value n35us represents 35 us, n140us represents 140 us. If the
field is absent, 210 us is applied.

TABLE 6

| Conditional Presence | Explanation |
|---|---|
| ServingCellChange | The field is mandatory present in the |
| | RRCReconfiguration message at change of |
| | AS security key derived from K_{gNB}. |
| | Otherwise, it is optionally present, need M. The |
| | field is absent in RRCResume and RRCSetup |
| | messages. |

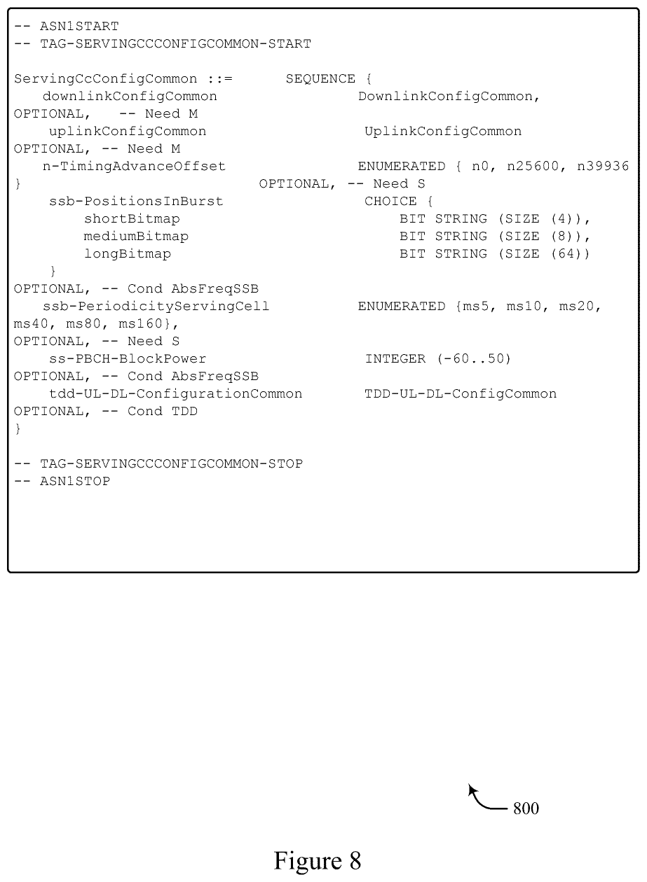

FIG. 8 illustrates IE contents 800 for an IE used to configure CC-specific common parameters of an aggregated cell in accordance with aspects of the present disclosure. For example, an NE may transmit, to a UL, a serving cell configuration that includes the IE with IE contents 800. The IE may be defined as an ServingCcConfigCommon IE and may include fields for downlink and uplink common configurations, as well as parameters for SSB positioning and periodicity. Further details of information included in the IE are shown in Tables 7 and 8 below.

TABLE 7
ServingCcConfigCommon field descriptions

n-TimingAdvanceOffset
The N_TA-Offset to be applied for random access on this component
carrier. If the field is absent, the UE applies the value defined for
the duplex mode and frequency range of this serving cell.
downlinkConfigCommon
The common downlink configuration of this component carrier, including
the frequency information configuration and the initial downlink BWP
common configuration.
uplinkConfigCommon
The common uplink configuration of this component carrier, including
the frequency information configuration and the initial uplink
BWP common configuration.
ssb-PositionsInBurst
Time domain positions of the transmitted SS-blocks in an SS-burst.
ss-PBCH-BlockPower
Average energy per resource element (EPRE) of resources elements
that carry secondary synchronization signals in dBm that the
NW used for SSB transmission.
ssb-PeriodicityServingCell
The SSB periodicity in ms.
tdd-UL-DL-ConfigurationCommon
A component carrier-specific TDD UL/DL configuration.

TABLE 8

| Conditional Presence | Explanation |
|---|---|
| AbsFreqSSB | The field is absent when absoluteFrequencySSB |
| | in frequencyInfoDL is absent, otherwise the |
| | field is mandatory present. |
| TDD | The field is optionally present, Need R, for |
| | TDD cells; otherwise it is absent. |

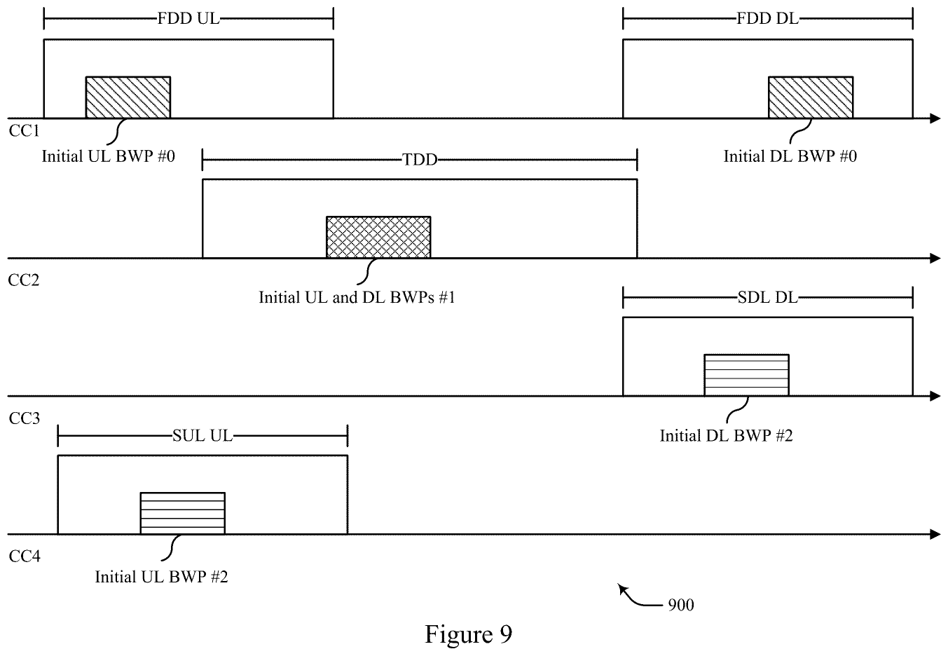

FIG. 9 illustrates an initial BWP configuration 900 in accordance with aspects of the present disclosure. The initial BWP configuration 900 may implement or be implemented by aspects of the wireless communications system 100. For example, an NE (e.g., an NE 102) may configure a serving cell (e.g., an aggregated cell) with a set of CCs and a set of initial BWPs, as described herein, according to the initial BWP configuration 900. The NE 102 may transmit a serving cell configuration to a UE (e.g., a UE 104) as described with reference to FIG. 1.

The set of CCs includes a CC1, a CC2, a CC3, and a CC4. Each initial BWP is configured for uplink-only communications, downlink-only communications, or uplink-and-downlink communications. Further, each initial BWP is configured on a different CC (for an unpaired CC/uplink-and-downlink initial BWP) or a different pair of CCs (for a DL-only initial BWP and an UL-only initial BWP, respectively) of the set of CCs. In the example of FIG. 9, an initial UL BWP #0 and an initial DL BWP #0 are configured on the CC1, initial UL and DL BWPs #1 are configured on the CC2, an initial DL BWP #2 is configured on the CC3, and an initial UL BWP #2 is configured on the CC4.

The CCs in the initial BWP configuration 900 may be arranged across the same or different frequency bands. Additionally, each CC may be configured for uplink-only communications, downlink-only communications, or uplink-and-downlink communications, and to use FDD or TDD communications. As illustrated, the CC1 is configured for both uplink and downlink communications using FDD, the CC2 is configured for both uplink and downlink communications using TDD, the CC3 is configured for downlink communications as a supplementary downlink (SDL) carrier, and the CC4 is configured for uplink communications as an SUL carrier. The CC3 and the CC4 are associated with each other and coordinated operations.

The NE broadcasts SSBs via one or more CCs of the set of CCs (e.g., in one or more initial BWPs of the set of initial BWPs) for UEs to perform initial access tasks to connect to the serving cell. In implementations, the NE broadcasts an SSB in a synchronization raster entry of the serving cell, where the SSB includes a physical broadcast channel (PBCH) that provides information about other synchronization raster entries of the serving cell. The NE may broadcast an SSB on each synchronization raster entry, and each SSB indicates a corresponding CORESET/search space used for delivery of a corresponding SIB1. In turn, each SIB1 in each initial BWP provides configuration of common parameters for the corresponding initial BWP.

A UE can receive, from the NE, an indication of a set of synchronization raster entries of the serving cell. Each synchronization raster entry is associated with (e.g., mapped to) an initial BWP of the set of initial BWPs. The UE selects a synchronization raster entry from the set of synchronization raster entries, for example, based on a UE ID of the UE. The UE receives, in an initial BWP corresponding to the selected synchronization raster entry, an SSB for uplink synchronization with the serving cell. The UE determines parameters for the initial BWP based on the SSB. For example, the UE can acquire, based on the CORESET/search space indicated in the SSB, a SIB1 that indicates the parameters. Once the UE has obtained this information about the initial BWP, the UE can monitor the initial BWP for paging DCI.

In some examples, the UE receives, from the NE, an indication of a CC of the set of CCs and/or an indication of an initial BWP of the set of initial BWPs for performing random access. An idle or inactive UE camping on an initial BWP of the serving cell and attempting to access to the serving cell, or a connected UE performing a handover to the target serving cell or performing uplink synchronization to the serving cell, can initiate a random access procedure on the indicated CC/initial BWP. Additionally, or alternatively, the UE may receive an indication of a first CC of the set of CCs and/or a first initial BWP of the set of initial BWPs for monitoring for paging DCI. The first CC/initial BWP may be configured for downlink-only communications, such as the CC3/initial DL BWP #2, and may be paired with a second CC/initial BWP configured for uplink-only communications, such as the CC4/initial UL BWP #2. The UE monitors for paging DCI from the NE on the CC3/initial DL BWP #2 and, when triggered, initiates random access on the CC4/initial UL BWP #2. That is, the UE may determine an uplink-only CC and/or initial BWP for random access based on the uplink-only CC/initial BWP being paired with a downlink-only CC/initial BWP in which the UE monitors for paging DCI.

In other examples, the UE determines a CC and/or initial BWP for performing random access based on RACH configurations associated with the set of CCs and/or set of initial BWPs. In such examples, the UE can select, for uplink synchronization and random access, the CC and/or initial BWP having an earliest-occurring RACH occasion from among all available RACH occasions of the set of CCs and/or set of initial BWPs. The earliest-occurring RACH occasion can be defined as an earliest-occurring (e.g., first in a time domain) RACH occasion in which the UE is able to transmit a PRACH preamble, e.g., accounting for any switching delays. For example, if the UE is operating in an active initial BWP, but another initial BWP is associated with an earlier RACH occasion than the active initial BWP, the UE considers whether a PRACH preamble can be transmitted in the earlier RACH occasion after a time delay in which the UE switches to the other initial BWP.

After a successful random access procedure, the UE and the NE can communicate (e.g., transmit, receive) uplink messages (e.g., PUSCH, PUCCH) and downlink messages (e.g., PDSCH, PDCCH) in one or more of the initial BWPs of one or more of the CCs. The NE can schedule transmissions by communicating (e.g., transmitting, sending) one or more DCI messages via one or more CCs of the set of CCs. For instance, the NE can transmit one DCI per scheduled transmission and may transmit the DCI via the CC on which the transmission is scheduled, such that multiple DCIs are used to schedule multiple transmissions. Alternatively, the NE can transmit one DCI to schedule multiple transmissions (e.g., on a same CC or on different CCs). In some examples, a PDSCH or a PUSCH carrying a TB can be mapped to only one CC at a given transmission occasion. That is, different PDSCHs/PUSCHs carrying a same TB may each be mapped to a different CC (e.g., of a subset of the set of CCs). For example, the NE may schedule a TB on the CC1 for an initial transmission, and then may schedule a retransmission of the TB on the CC2. Since resource elements of a PDSCH/PUSCH are limited to a single CC, this method enables the UE to employ power saving techniques, such as micro-sleep, for non-scheduled CCs (e.g., the CC3 and the CC4), while maintaining the ability to exploit channel diversity across different CCs (e.g., the CC1 and the CC2).

In another example, the NE may schedule multiple transmissions (e.g., PDSCH or PUSCH) carrying a same TB on two or more CCs of the set of CCs. This example supports TB repetition across multiple CCs, which can increase packet delivery reliability without increasing latency. Thus, this example may be utilized for ultra-reliable and low-latency communication (URLLC) and/or for UEs in limited coverage areas (e.g., UEs associated with a relatively low operating signal-to-interference and noise ratio (SINR)). The NE can schedule the multiple transmissions using one or more DCIs.

As an illustrative example, in downlink communications, the NE may transmit, and the UE may receive, a DCI in the CC1, where the DCI schedules a set of PDSCH transmissions (e.g., carrying a same TB) on the CC2 and the CC3. As another example, the NE may transmit, and the UE may receive, a set of DCIs scheduling a set of PDSCH transmissions. The UE receives each DCI in a respective, different CC, where each DCI schedules a PDSCH transmission on the respective, different CC. In either case, the UE receives the set of PDSCH transmissions based on the DCI(s) and combines the PDSCH transmissions to decode the TB. In the context of FIG. 9, the UE can receive, via the CC1, a first DCI scheduling a first PDSCH transmission on the CC1, and can receive, via the CC2, a second DCI scheduling a second PDSCH transmission on the CC2. The first PDSCH transmission and the second PDSCH transmission carry a same TB.

In an example of uplink communications, the NE may transmit, and the UE may receive, a DCI in the CC1, where the DCI schedules a set of PUSCH transmissions (e.g., carrying a same TB) on the CC2 and the CC3. As another example, the NE may transmit, and the UE may receive, a set of DCIs scheduling a set of PUSCH transmissions. The UE receives each DCI in a respective, different CC, where each DCI schedules a PUSCH transmission on the respective, different CC. In either case, the NE receives, from the UE, the set of PUSCH transmissions based on the DCI(s) and combines the PUSCH transmissions to decode the TB. In the context of FIG. 9, the UE can receive, via the CC1, a first DCI scheduling a first PUSCH transmission on the CC1, and can receive, via the CC2, a second DCI scheduling a second PUSCH transmission on the CC2. The first PDSCH transmission and the second PDSCH transmission carry a same TB.

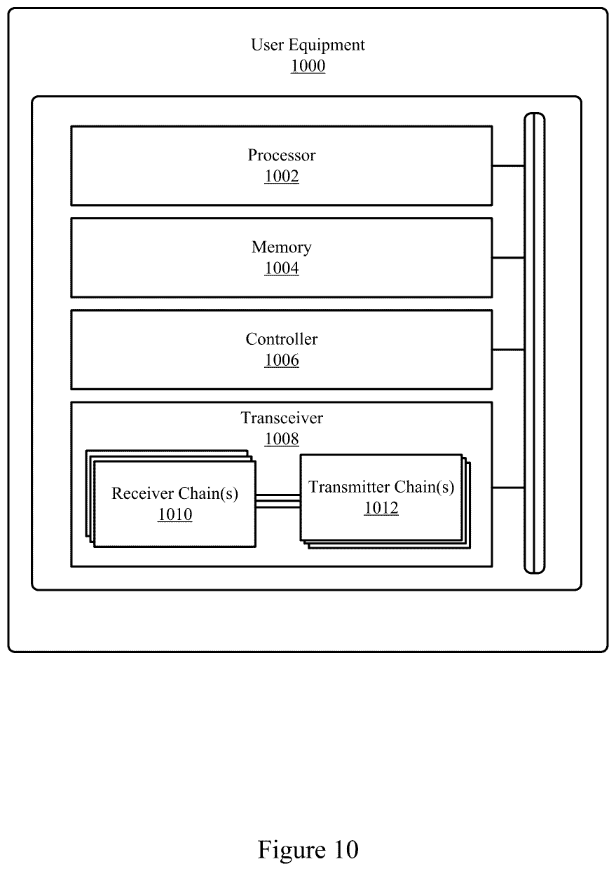

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving a configuration for a serving cell, where the serving cell is associated with a set of CCs, and where the configuration indicates at least one PCID associated with the serving cell, and receiving wireless communication from the serving cell via a set of downlink channels associated with the set of CCs and based on the at least one PCID.

Additionally, the UE 1000 may be configured to support any one or combination of the method further comprises sharing a same frame timing, a same SFN, and a same HARQ entity among the set of CCs. Additionally, or alternatively, the method further comprises the configuration indicates that the at least one PCID is associated with the set of CCs, and the UE 1000 receives at least one SSB of the serving cell via at least one CC of the set of CCs, where the at least one SSB is associated with the at least one PCID. Additionally, or alternatively, the method further comprises the at least one PCID includes a set of PCIDs, and where each PCID of the set of PCIDs is associated with a different CC of the set of CCs. Additionally, or alternatively, the method further comprises receiving a set of SSBs, where each SSB of the set of the SSBs is associated with a different PCID of the set of PCIDs and is received via a different CC of the set of CCs.

Additionally, or alternatively, the method further comprises identifying a request for the UE to perform a handover procedure with a target serving cell based on the configuration, where the serving cell is the target serving cell, receiving an indication of a CC of the set of CCs for synchronization with the target serving cell, and initiating a random access procedure to the target serving cell on the CC. Additionally, or alternatively, the method further comprises receiving a message indicating a CC of the set of CCs for monitoring for a paging DCI, and monitoring for the paging DCI on the CC. Additionally, or alternatively, the method further comprises the message includes a MAC-CE.

Additionally, or alternatively, the method further comprises the set of downlink channels include a set of PDSCHs carrying a same TB, and the UE 1000 receives each PDSCH of the set of PDSCHs via a different CC of the set of CCs. Additionally, or alternatively, the method further comprises receiving a DCI via a CC of the set of CCs, where the DCI schedules the set of PDSCHs. Additionally, or alternatively, the method further comprises receiving a set of DCI scheduling the set of PDSCHs, where each DCI of the set of DCI is received via the different CC of the set of CCs.

Additionally, or alternatively, the method further comprises transmitting each PUSCH of a set of PUSCHs carrying a same TB via a different CC of the set of CCs. Additionally, or alternatively, the method further comprises receiving a DCI via a CC of the set of CCs, where the DCI schedules the set of PUSCHs. Additionally, or alternatively, the method further comprises receiving a set of DCI scheduling the set of PUSCHs, where each DCI of the set of DCI is received via the different CC of the set of CCs. Additionally, or alternatively, the method further comprises each CC of the set of CCs is configured with one of an uplink-only configuration, a downlink-only configuration, or an uplink-and-downlink configuration.

Additionally, or alternatively, the UE 1000 may support at least one memory (e.g., the memory 1004) and at least one processor (e.g., the processor 1002) coupled with the at least one memory and configured to cause the UE 1000 to receive a configuration for a serving cell, where the serving cell is associated with a set of CCs, and where the configuration indicates at least one PCID associated with the serving cell, and receive wireless communication from the serving cell via a set of downlink channels associated with the set of CCs and based on the at least one PCID.

Additionally, the UE 1000 may be configured to support any one or combination of sharing a same frame timing, a same SFN, and a same HARQ entity among the set of CCs. Additionally, or alternatively, the configuration indicates that the at least one PCID is associated with the set of CCs, and the at least one processor is further configured to cause the UE to receive at least one SSB of the serving cell via at least one CC of the set of CCs, where the at least one SSB is associated with the at least one PCID. Additionally, or alternatively, the at least one PCID includes a set of PCIDs, and where each PCID of the set of PCIDs is associated with a different CC of the set of CCs. Additionally, or alternatively, the at least one processor is further configured to cause the UE 1000 to receive a set of SSBs, where each SSB of the set of the SSBs is associated with a different PCID of the set of PCIDs and is received via a different CC of the set of CCs.

Additionally, or alternatively, the at least one processor is further configured to cause the UE 1000 to identify a request for the UE 1000 to perform a handover procedure with a target serving cell based on the configuration, where the serving cell is the target serving cell, receive an indication of a CC of the set of CCs for synchronization with the target serving cell, and initiate a random access procedure to the target serving cell on the CC. Additionally, or alternatively, the at least one processor is further configured to cause the UE 1000 to receive a message indicating a CC of the set of CCs for monitoring for a paging DCI, and monitor for the paging DCI on the CC. Additionally, or alternatively, the message includes a MAC-CE.

Additionally, or alternatively, the set of downlink channels includes a set of PDSCHs carrying a same TB, and the at least one processor is further configured to cause the UE 1000 to receive each PDSCH of the set of PDSCHs via a different CC of the set of CCs. Additionally, or alternatively, the at least one processor is further configured to cause the UE 1000 to receive a DCI via a CC of the set of CCs, where the DCI schedules the set of PDSCHs. Additionally, or alternatively, the at least one processor is further configured to cause the UE 1000 to receive a set of DCI scheduling the set of PDSCHs, where each DCI of the set of DCI is received via the different CC of the set of CCs.

Additionally, or alternatively, the at least one processor is further configured to cause the UE 1000 to transmit each PUSCH of a set of PUSCHs carrying a same TB via a different CC of the set of CCs. Additionally, or alternatively, the at least one processor is further configured to cause the UE 1000 to receive a DCI via a CC of the set of CCs, where the DCI schedules the set of PUSCHs. Additionally, or alternatively, the at least one processor is further configured to cause the UE 1000 to receive a set of DCI scheduling the set of PUSCHs, where each DCI of the set of DCI is received via the different CC of the set of CCs. Additionally, or alternatively, each CC of the set of CCs is configured with one of an uplink-only configuration, a downlink-only configuration, or an uplink-and-downlink configuration.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

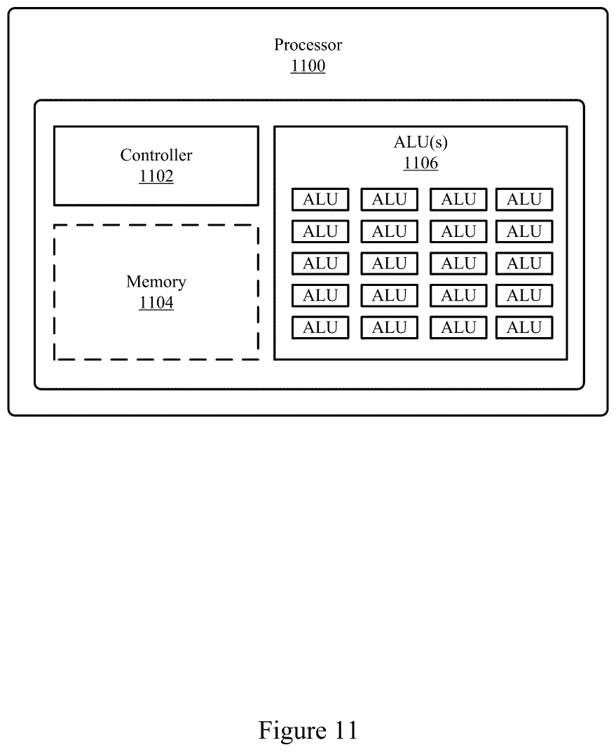

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a configuration for a serving cell, where the serving cell is associated with a set of CCs, and where the configuration indicates at least one PCID associated with the serving cell, and receive wireless communication from the serving cell via a set of downlink channels associated with the set of CCs and based on the at least one PCID.

Additionally, the processor 1100 may be configured to or operable to support any one or combination of sharing a same frame timing, a same SFN, and a same HARQ entity among the set of CCs. Additionally, or alternatively, the configuration indicates that the at least one PCID is associated with the set of CCs, and the at least one controller is further configured to cause the processor 1100 to receive at least one SSB of the serving cell via at least one CC of the set of CCs, where the at least one SSB is associated with the at least one PCID. Additionally, or alternatively, the at least one PCID includes a set of PCIDs, and where each PCID of the set of PCIDs is associated with a different CC of the set of CCs. Additionally, or alternatively, the at least one controller is further configured to cause the processor 1100 to receive a set of SSBs, where each SSB of the set of the SSBs is associated with a different PCID of the set of PCIDs and is received via a different CC of the set of CCs.

Additionally, or alternatively, the at least one controller is further configured to cause the processor 1100 to identify a request for the processor 1100 to perform a handover procedure with a target serving cell based on the configuration, where the serving cell is the target serving cell, receive an indication of a CC of the set of CCs for synchronization with the target serving cell, and initiate a random access procedure to the target serving cell on the CC. Additionally, or alternatively, the at least one controller is further configured to cause the processor 1100 to receive a message indicating a CC of the set of CCs for monitoring for a paging DCI, and monitor for the paging DCI on the CC. Additionally, or alternatively, the message includes a MAC-CE.

Additionally, or alternatively, the set of downlink channels includes a set of PDSCHs carrying a same TB, and the at least one processor is further configured to cause the processor 1100 to receive each PDSCH of the set of PDSCHs via a different CC of the set of CCs. Additionally, or alternatively, the at least one controller is further configured to cause the processor 1100 to receive a DCI via a CC of the set of CCs, where the DCI schedules the set of PDSCHs. Additionally, or alternatively, the at least one controller is further configured to cause the processor 1100 to receive a set of DCI scheduling the set of PDSCHs, where each DCI of the set of DCI is received via the different CC of the set of CCs.

Additionally, or alternatively, the at least one controller is further configured to cause the processor 1100 to transmit each PUSCH of a set of PUSCHs carrying a same TB via a different CC of the set of CCs. Additionally, or alternatively, the at least one controller is further configured to cause the processor 1100 to receive a DCI via a CC of the set of CCs, where the DCI schedules the set of PUSCHs. Additionally, or alternatively, the at least one controller is further configured to cause the processor 1100 to receive a set of DCI scheduling the set of PUSCHs, where each DCI of the set of DCI is received via the different CC of the set of CCs. Additionally, or alternatively, each CC of the set of CCs is configured with one of an uplink-only configuration, a downlink-only configuration, or an uplink-and-downlink configuration.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to transmit a configuration for a serving cell, where the serving cell is associated with a set of CCs, and where the configuration indicates at least one PCID associated with the serving cell, and transmit wireless communication via a set of downlink channels associated with the set of CCs and based on the at least one PCID.

Additionally, the processor 1100 may be configured to or operable to support any one or combination of sharing a same frame timing, a same SFN, and a same HARQ entity among the set of CCs. Additionally, or alternatively, the configuration indicates that the at least one PCID is associated with the set of CCs, and the at least one controller is further configured to cause the processor 1100 to transmit at least one SSB of the serving cell via at least one CC of the set of CCs, where the at least one SSB is associated with the at least one PCID. Additionally, or alternatively, the at least one PCID includes a set of PCIDs, and where each PCID of the set of PCIDs is associated with a different CC of the set of CCs. Additionally, or alternatively, the at least one controller is further configured to cause the processor 1100 to transmit a set of SSBs, where each SSB of the set of the SSBs is associated with a different PCID of the set of PCIDs and is transmitted via a different CC of the set of CCs.

Additionally, or alternatively, the at least one controller is further configured to cause the processor 1100 to transmit a request for a UE to perform a handover procedure with a target serving cell based on the configuration, where the serving cell is the target serving cell, and transmit an indication of a CC of the set of CCs for synchronization with the target serving cell. Additionally, or alternatively, to the at least one controller is further configured to cause the processor 1100 to transmit a message indicating a CC of the set of CCs for monitoring for a paging DCI, and transmit the paging DCI via the CC. Additionally, or alternatively, the message includes a medium access control MAC-CE.

Additionally, or alternatively, the set of downlink channels include a set of PDSCHs carrying a same TB, and the at least one controller is further configured to cause the processor 1100 to transmit each PDSCH of the set of PDSCHs via a different CC of the set of CCs. Additionally, or alternatively, the at least one controller is further configured to cause the processor 1100 to transmit a DCI via a CC of the set of CCs, where the DCI schedules the set of PDSCHs. Additionally, or alternatively, the at least one controller is further configured to cause the processor 1100 to transmit a set of DCI scheduling the set of PDSCHs, where each DCI of the set of DCI is transmitted via the different CC of the set of CCs. Additionally, or alternatively, the at least one controller is further configured to cause the processor 1100 to receive each PUSCH of a set of PUSCHs carrying a same TB via a different CC of the set of CCs. Additionally, or alternatively, the at least one controller is further configured to cause the processor 1100 to transmit a DCI via a CC of the set of CCs, where the DCI schedules the set of PUSCHs. Additionally, or alternatively, the at least one controller is further configured to cause the processor 1100 to transmit a set of DCI scheduling the set of PUSCHs, where each DCI of the set of DCI is transmitted via the different CC of the set of CCs. Additionally, or alternatively, each CC of the set of CCs is configured with one of an uplink-only configuration, a downlink-only configuration, or an uplink-and-downlink configuration.

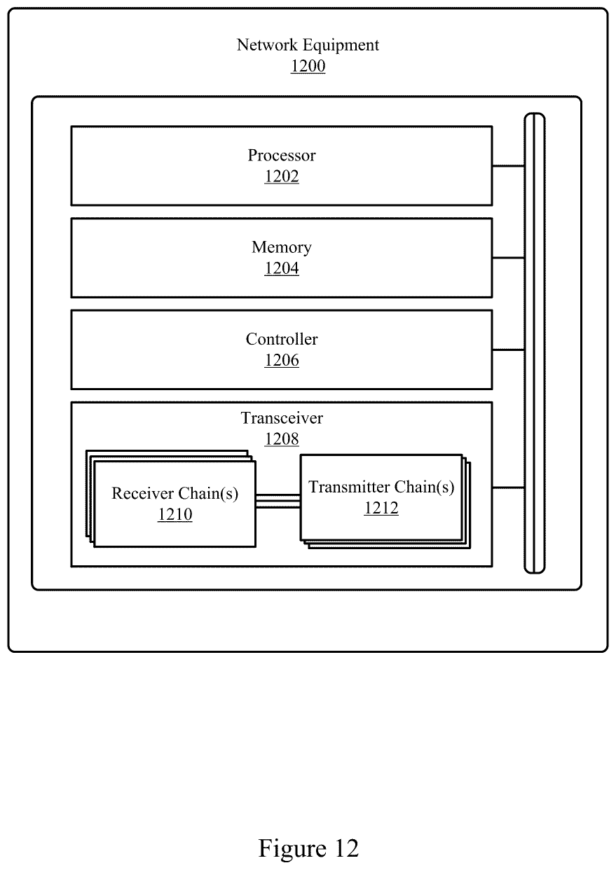

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting a configuration for a serving cell, where the serving cell is associated with a set of CCs, and where the configuration indicates at least one PCID associated with the serving cell, and transmitting wireless communication via a set of downlink channels associated with the set of CCs and based on the at least one PCID.

Additionally, the NE 1200 may be configured to or operable to support any one or combination of sharing a same frame timing, a same SFN, and a same HARQ entity among the set of CCs. Additionally, or alternatively, the configuration indicates that the at least one PCID is associated with the set of CCs, and the method further comprises transmitting at least one SSB of the serving cell via at least one CC of the set of CCs, where the at least one SSB is associated with the at least one PCID. Additionally, or alternatively, the at least one PCID includes a set of PCIDs, and where each PCID of the set of PCIDs is associated with a different CC of the set of CCs. Additionally, or alternatively, the method further comprises transmitting a set of SSBs, where each SSB of the set of the SSBs is associated with a different PCID of the set of PCIDs and is transmitted via a different CC of the set of CCs.

Additionally, or alternatively, the method further comprises transmitting a request for a UE to perform a handover procedure with a target serving cell based on the configuration, where the serving cell is the target serving cell, and transmitting an indication of a CC of the set of CCs for synchronization with the target serving cell. Additionally, or alternatively, the method further comprises transmitting a message indicating a CC of the set of CCs for monitoring for a paging DCI, and transmitting the paging DCI via the CC. Additionally, or alternatively, the message includes a medium access control MAC-CE.

Additionally, or alternatively, the set of downlink channels include a set of PDSCHs carrying a same TB, and the method further comprises transmitting each PDSCH of the set of PDSCHs via a different CC of the set of CCs. Additionally, or alternatively, the method further comprises transmitting a DCI via a CC of the set of CCs, where the DCI schedules the set of PDSCHs. Additionally, or alternatively, the method further comprises transmitting a set of DCI scheduling the set of PDSCHs, where each DCI of the set of DCI is transmitted via the different CC of the set of CCs. Additionally, or alternatively, the method further comprises receiving each PUSCH of a set of PUSCHs carrying a same TB via a different CC of the set of CCs. Additionally, or alternatively, the method further comprises transmitting a DCI via a CC of the set of CCs, where the DCI schedules the set of PUSCHs. Additionally, or alternatively, the method further comprises transmitting a set of DCI scheduling the set of PUSCHs, where each DCI of the set of DCI is transmitted via the different CC of the set of CCs. Additionally, or alternatively, each CC of the set of CCs is configured with one of an uplink-only configuration, a downlink-only configuration, or an uplink-and-downlink configuration.

Additionally, or alternatively, the NE 1200 may support at least one memory (e.g., the memory 1204) and at least one processor (e.g., the processor 1202) coupled with the at least one memory and configured to cause the NE to transmit a configuration for a serving cell, where the serving cell is associated with a set of CCs, and where the configuration indicates at least one PCID associated with the serving cell, and transmit wireless communication via a set of downlink channels associated with the set of CCs and based on the at least one PCID.

Additionally, the NE 1200 may be configured to support any one or combination of sharing a same frame timing, a same SFN, and a same HARQ entity among the set of CCs. Additionally, or alternatively, the configuration indicates that the at least one PCID is associated with the set of CCs, and the at least one processor is further configured to cause the NE 1200 to transmit at least one SSB of the serving cell via at least one CC of the set of CCs, where the at least one SSB is associated with the at least one PCID. Additionally, or alternatively, the at least one PCID includes a set of PCIDs, and where each PCID of the set of PCIDs is associated with a different CC of the set of CCs. Additionally, or alternatively, the at least one processor is further configured to cause the NE 1200 to transmit a set of SSBs, where each SSB of the set of the SSBs is associated with a different PCID of the set of PCIDs and is transmitted via a different CC of the set of CCs.

Additionally, or alternatively, the at least one processor is further configured to cause the NE 1200 to transmit a request for a UE to perform a handover procedure with a target serving cell based on the configuration, where the serving cell is the target serving cell, and transmit an indication of a CC of the set of CCs for synchronization with the target serving cell. Additionally, or alternatively, to the at least one processor is further configured to cause the NE 1200 to transmit a message indicating a CC of the set of CCs for monitoring for a paging DCI, and transmit the paging DCI via the CC. Additionally, or alternatively, the message includes a medium access control MAC-CE.

Additionally, or alternatively, the set of downlink channels include a set of PDSCHs carrying a same TB, and the at least one processor is further configured to cause the NE 1200 to transmit each PDSCH of the set of PDSCHs via a different CC of the set of CCs. Additionally, or alternatively, the at least one processor is further configured to cause the NE 1200 to transmit a DCI via a CC of the set of CCs, where the DCI schedules the set of PDSCHs. Additionally, or alternatively, the at least one processor is further configured to cause the NE 1200 to transmit a set of DCI scheduling the set of PDSCHs, where each DCI of the set of DCI is transmitted via the different CC of the set of CCs. Additionally, or alternatively, the at least one processor is further configured to cause the NE 1200 to receive each PUSCH of a set of PUSCHs carrying a same TB via a different CC of the set of CCs. Additionally, or alternatively, the at least one processor is further configured to cause the NE 1200 to transmit a DCI via a CC of the set of CCs, where the DCI schedules the set of PUSCHs. Additionally, or alternatively, the at least one processor is further configured to cause the NE 1200 to transmit a set of DCI scheduling the set of PUSCHs, where each DCI of the set of DCI is transmitted via the different CC of the set of CCs. Additionally, or alternatively, each CC of the set of CCs is configured with one of an uplink-only configuration, a downlink-only configuration, or an uplink-and-downlink configuration.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

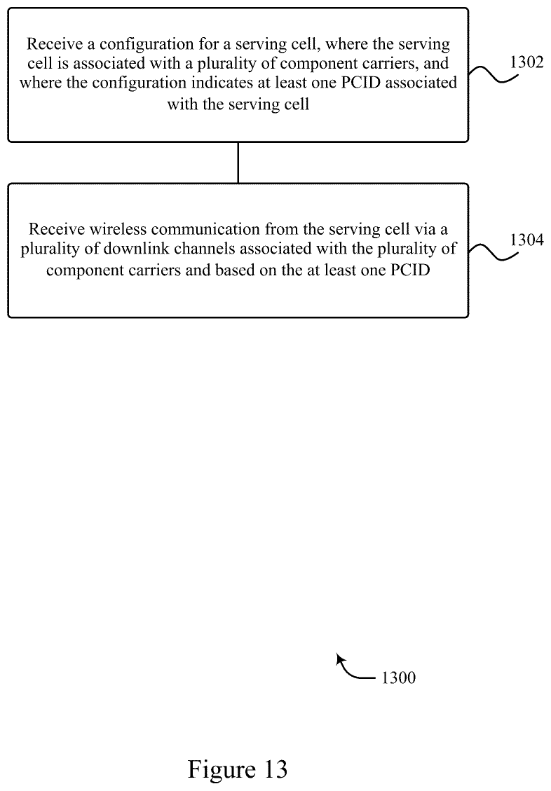

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving a configuration for a serving cell, where the serving cell is associated with a plurality of CCs, and where the configuration indicates at least one PCID associated with the serving cell. The operations of 1302 may be performed in accordance with examples as described herein. In some implementations, aspects of the operations of 1302 may be performed by a UE as described with reference to FIG. 10.

At 1304, the method may include receiving wireless communication from the serving cell via a plurality of downlink channels associated with the plurality of CCs and based on the at least one PCID. The operations of 1304 may be performed in accordance with examples as described herein. In some implementations, aspects of the operations of 1304 may be performed by a UE as described with reference to FIG. 10.

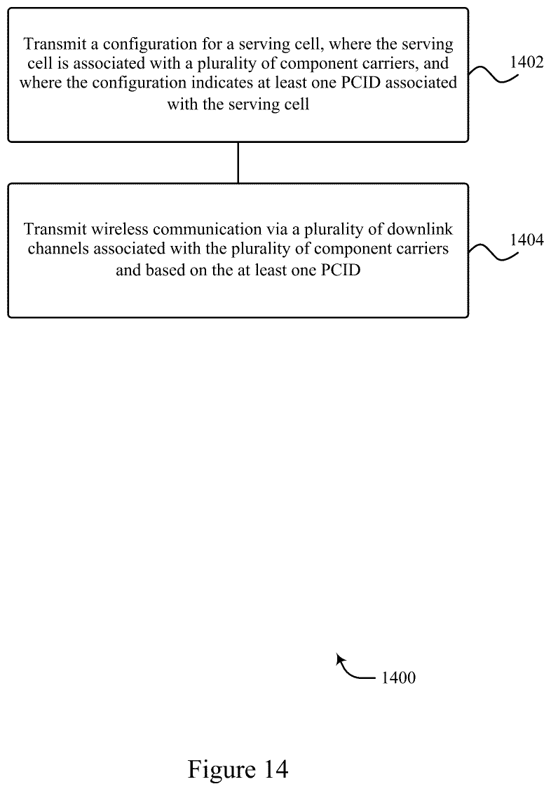

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting a configuration for a serving cell, where the serving cell is associated with a plurality of CCs, and where the configuration indicates at least one PCID associated with the serving cell. The operations of 1402 may be performed in accordance with examples as described herein. In some implementations, aspects of the operations of 1402 may be performed by a NE as described with reference to FIG. 12.

At 1404, the method may include transmitting wireless communication via a plurality of downlink channels associated with the plurality of CCs and based on the at least one PCID. The operations of 1404 may be performed in accordance with examples as described herein. In some implementations, aspects of the operations of 1404 may be performed by a NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a configuration for a serving cell, wherein the serving cell is associated with
a plurality of component carriers, and wherein the configuration indicates at least one physical cell identity (PCID) associated with the serving cell; and
receive wireless communication from the serving cell via a plurality of downlink channels associated with the plurality of component carriers and based at least in part on the at least one PCID.

2. The UE of claim 1, wherein the plurality of component carriers share a same frame timing, a same system frame number (SFN), and a same hybrid automatic repeat request (HARQ) entity.

3. The UE of claim 1, wherein the configuration indicates that the at least one PCID is associated with the plurality of component carriers, and wherein, to receive wireless communication, the at least one processor is further operable to cause the UE to receive at least one synchronization signal block (SSB) of the serving cell via at least one component carrier of the plurality of component carriers, wherein the at least one SSB is associated with the at least one PCID.

4. The UE of claim 1, wherein the at least one PCID comprises a set of PCIDs, and wherein each PCID of the set of PCIDs is associated with a different component carrier of the plurality of component carriers.

5. The UE of claim 4, wherein, to receive wireless communication, the at least one processor is further operable to cause the UE to receive a plurality of synchronization signal blocks (SSBs), wherein each SSB of the plurality of the SSBs is associated with a different PCID of the set of PCIDs and is received via a different component carrier of the plurality of component carriers.

6. The UE of claim 1, wherein, to receive wireless communication, the at least one processor is further operable to cause the UE to:
identify a request for the UE to perform a handover procedure with a target serving cell based at least in part on the configuration, wherein the serving cell is the target serving cell;
receive an indication of a component carrier of the plurality of component carriers for synchronization with the target serving cell; and
initiate a random access procedure to the target serving cell on the component carrier.

7. The UE of claim 1, wherein, to receive wireless communication, the at least one processor is further operable to cause the UE to:
receive a message indicating a component carrier of the plurality of component carriers for monitoring for a paging downlink control information (DCI); and
monitor for the paging DCI on the component carrier.

8. The UE of claim 7, wherein the message comprises a medium access control (MAC) control element (MAC-CE).

9. The UE of claim 1, wherein the plurality of downlink channels comprise a plurality of physical downlink shared channels (PDSCHs) carrying a same transport block (TB), and wherein, to receive wireless communication, the at least one processor is further operable to cause the UE to receive each PDSCH of the plurality of PDSCHs via a different component carrier of the plurality of component carriers.

10. The UE of claim 9, wherein the at least one processor is further operable to cause the UE to receive a downlink control information (DCI) via a component carrier of the plurality of component carriers, wherein the DCI schedules the plurality of PDSCHs.

11. The UE of claim 9, wherein the at least one processor is further operable to cause the UE to receive a set of downlink control information (DCI) scheduling the plurality of PDSCHs, wherein each DCI of the set of DCI is received via the different component carrier of the plurality of component carriers.

12. The UE of claim 1, wherein the at least one processor is further operable to cause the UE to transmit each physical uplink shared channel (PUSCH) of a plurality of PUSCHs carrying a same transport block (TB) via a different component carrier of the plurality of component carriers.

13. The UE of claim 12, wherein the at least one processor is further operable to cause the UE to receive a downlink control information (DCI) via a component carrier of the plurality of component carriers, wherein the DCI schedules the plurality of PUSCHs.

14. The UE of claim 12, wherein the at least one processor is further operable to cause the UE to receive a set of downlink control information (DCI) scheduling the plurality of PUSCHs, wherein each DCI of the set of DCI is received via the different component carrier of the plurality of component carriers.

15. The UE of claim 1, wherein each component carrier of the plurality of component carriers is configured with one of an uplink-only configuration, a downlink-only configuration, or an uplink-and-downlink configuration.

16. A network equipment (NE) for wireless communication, comprising:
at least one memory; and
at least one processor coupled with the at least one memory and operable to cause the NE to:
transmit a configuration for a serving cell, wherein the serving cell is associated with a plurality of component carriers, and wherein the configuration indicates at least one physical cell identity (PCID) associated with the serving cell; and
transmit wireless communication via a plurality of downlink channels associated with the plurality of component carriers and based at least in part on the at least one PCID.

17. The NE of claim 16, wherein the configuration indicates that the at least one PCID is associated with the plurality of component carriers, and wherein, to transmit wireless communication, the at least one processor is further operable to cause the NE to transmit at least one synchronization signal block (SSB) of the serving cell via at least one component carrier of the plurality of component carriers, wherein the at least one SSB is associated with the at least one PCID.

18. The NE of claim 16, wherein the at least one PCID comprises a set of PCIDs, and wherein each PCID of the set of PCIDs is associated with a different component carrier of the plurality of component carriers.

19. A method performed by a user equipment (UE), the method comprising:
receiving a configuration for a serving cell, wherein the serving cell is associated with a plurality of component carriers, and wherein the configuration indicates at least one physical cell identity (PCID) associated with the serving cell; and
receiving wireless communication from the serving cell via a plurality of downlink channels associated with the plurality of component carriers and based at least in part on the at least one PCID.

20. A method performed by a network equipment (NE), the method comprising:
transmitting a configuration for a serving cell, wherein the serving cell is associated with a plurality of component carriers, and wherein the configuration indicates at least one physical cell identity (PCID) associated with the serving cell; and
transmitting wireless communication via a plurality of downlink channels associated with the plurality of component carriers and based at least in part on the at least one PCID.
